(19) United States
(12) Patent Application Publication
(10) Pub. No.: US 2010/0024409 A1
(43) Pub. Date: Feb. 4, 2010

(54) CONTROL SYSTEM FOR VARIABLE DISPLACEMENT PUMP-MOTOR TYPE TRANSMISSION

(75) Inventors: Takahiro Shiina, Shizuoka (JP); Makoto Funahashi, Shizuoka (JP); Akira Murakami, Shizuoka (JP); Masafumi Yamamoto, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/518,427

(22) PCT Filed: Dec. 17, 2007
(86) PCT No.: PCT/JP07/74609

§ 371 Date: Jun. 10, 2009

(30) Foreign Application Priority Data
Dec. 20, 2006 (JP) 2006-343371

(51) Int. Cl. F16H 61/44

(52) U.S. Cl. 60/327; 60/420

(57) ABSTRACT

A control system for a variable displacement pump-motor type transmission includes: a judging mechanism judging a fact that the discharging amount of any one of the variable displacement pump-motors is zero; and a speed change controller carrying out a control to disable one of the transmission mechanism to transmit the power from the prime mover to the output member by actuating a synchronizer, in case the judging mechanism judges that the discharging amount of the one of the pump-motors functioning to transmit the power from the prime mover to the output member through the one of the transmission mechanism is zero. The control system can carry out a speed change operation of a variable displacement pump-motor type transmission without raising the speed of the prime mover abruptly, by judging a fixed stage set by locking one of the pump-motors.

### TECHNICAL FIELD

This invention relates to a control system for a transmission, which comprises at least one pair of variable displacement pump-motors capable of transferring operating fluid therebetween, at least two transmission mechanisms for transmitting torque transmitted by the variable displacement pump-motors to an output member, and a changeover mechanism enabling and disabling the transmission mechanisms to transmit power, and which is capable of setting a fixed stage governed by a speed change ratio of any of the transmission mechanism and a continuously variable sped change ratio by varying the power transmitted between the variable displacement pump-motors through the operating fluid.

### BACKGROUND ART

The transmission of this kind is disclosed in Japanese Patent Laid-Open No. 2006-266493. According to the teachings of Japanese Patent Laid-Open No. 2006-266493, variable displacement hydraulic pump motors are respectively connected with reaction elements of a pair of planetary gear mechanisms, and outlet ports of the hydraulic pump motors are connected with each other and inlet ports of the hydraulic pump motors are connected with each other to form a closed circuit. A power outputted from a power source such as an engine is inputted to an input element of the planetary gear mechanism. Drive gears for setting a fixed stage are arranged on intermediate shafts integrated with output elements of the planetary gear mechanisms, and driven gears respectively meshing with the drive gears is arranged on an output shaft. The transmission further comprises a synchronous engaging mechanism (i.e., a synchronizer) enabling and disabling gear pairs formed of those drive gears and driven gears to transmit torque.

Therefore, if the reaction element is fixed by locking any of the hydraulic pump motors, the power outputted from the prime mover is transmitted to one of the intermediate shaft through the planetary gear mechanism to which the fixed reaction element belongs, and then, the power is transmitted to the output shaft through the gear pair connected with the intermediate shaft by the synchronizer. In this situation, the speed change ratio is governed by a gear ratio of the gear pair being involved in the power transmission.

In this case, the hydraulic pump motor is locked by reducing a discharging amount of other hydraulic pump motor to zero. As explained, since those hydraulic pump motors are communicated through the closed circuit, operating oil will not be flown by reducing the discharging amount of the other hydraulic pump motor to zero. Therefore, one of the hydraulic pump motors is locked and the rotation thereof is halted by increasing the discharging amount thereof larger than zero, e.g., to maximum.

In case the discharging amounts of both of hydraulic pump motors are increased larger than zero, while enabling a predetermined gear pair to transmit the torque by the synchronizer of one of the hydraulic pump motor side and enabling the other gear pair to transmit the torque by the synchronizer of the other hydraulic pump motor side, a speed change ratio can be set to a ratio between speed change ratios governed by gear ratios of the gear pairs. That is, one of the hydraulic pump motors generates the operating oil, and the generated operating oil is fed to the other hydraulic pump motor to drive the other hydraulic pump motor as a motor. Power of the other hydraulic pump motor functioning as a motor is transmitted to the output shaft through the other gear pair. As a result, a synthesized power of the power transmitted through the fluid and the power transmitted mechanically is transmitted to the output shaft. Here, the power transmitted through the fluid can be varied continuously by varying the discharging amounts of the hydraulic pump motors continuously. Therefore, a total speed change ratio of the transmission can be set continuously and steplessly.

According to the transmission taught by Japanese Patent Laid-Open No. 2006-266493, in case of setting the speed change ratio beyond the speed change ratio governed by the gear ratio of any of the gear pair, the gear pair to be used to transmit the power is switched by the synchronizer. Specifically, the synchronizer of one of the intermediate shaft is moved to the gear pair of opposite side to be engaged therewith through a neutral position to transmit the power by the engaged gear pair, while keeping the synchronizer other intermediate shaft being engaged. During the process of switching the gear pair used to transmit the power, a fixed stage is set temporarily, and the gear pair to be engaged with the synchronizer not being involved in the power transmission is switched. That is, the gear pair to be engaged with the synchronizer connected with the hydraulic pump motor whose discharging amount is zero is switched.

In case of carrying out the above-explained speed change operation, the fixed stage is set by increasing the discharging amount of the hydraulic pump motor being connected with the gear pair to set the fixed stage larger than zero, and by decreasing the discharging amount of the other hydraulic pump motor to zero thereby halting the feeding and discharging of the operating oil to/from said one of the hydraulic pump motor. However, in case of carrying out the switching operation of the changeover mechanism such as a synchronizer when a command signal is being outputted to set the fixed stage, such switching operation of the changeover mechanism may be carried out under the situation where the fixed stage has not yet been set certainly. For example, a neutral stage may be set temporarily by a changeover behavior of the changeover mechanism during the delay in setting the fixed stage from the instance when the command signal for setting the fixed stage is outputted to the instance when the fixed stage is actually set, or one of the hydraulic pump motor may not be locked certainly due to leakage of the operating oil.

In those cases, the torque of the prime mover is acting on the hydraulic pump motor of the side of the changeover mechanism by which the switching operation is carried out. Therefore, reaction force against the torque acting on said oil pump motor is no longer established when the changeover mechanism is brought into the neutral state. As a result, the torque or the power may idle away and the rotational speed of the prime mover is thereby raised abruptly. For this reason, the driver may feel uncomfortable feeling. In the prior art, a technology for detecting or judging a locked state of one of the hydraulic pump motors during the speed change operation or an establishment of the resultant fixed stage, and a technology of incorporating such detection or judgment into a speed change control have not yet been developed. Therefore, the speed change operation of the transmission using a hydraulic motor or a pump motor is difficult to be carried out smoothly and promptly.

### DISCLOSURE OF THE INVENTION

The present invention has been conceived noting the technical problems thus far described, and its object is to provide a control system, which is capable of judging an establishment of a fixed stage resulting from a changeover behavior of a changeover mechanism in a continuously variable transmission using a variable displacement pump-motor, and capable of judging a fact that one of the pump-motor is locked by the other pump-motor, for the purpose of carrying out a speed change operation without raising a rotational speed of a prime mover abruptly.

In order to achieve the above-mentioned object, according to the present invention, there is provided a control system for a variable displacement pump-motor type transmission, having a first variable displacement pump-motor and a second variable displacement pump-motor which are communicated with each other in a manner to interrupt feeding and discharging of an operating fluid to/from one of the variable displacement pump-motors to lock said one of the variable displacement pump-motors when discharging amount of the other variable displacement pump-motor is zero, a first transmission mechanism transmitting power from a prime mover to an output member in case the first variable displacement pump-motor is locked, a second transmission mechanism transmitting power from the prime mover to the output member in case the second variable displacement pump-motor is locked, a first changeover mechanism for enabling the first transmission mechanism to transmit the power, and a second changeover mechanism for enabling the second transmission mechanism to transmit the power, characterized by comprising: a judging means for judging a fact that the discharging amount of any one of the variable displacement pump-motors is zero; and a speed change control means for carrying out a control to disable a power transmission of one of the transmission mechanisms transmitting the power from the prime mover to the output member by actuating one of the changeover mechanisms, in case the judging means judges that the discharging amount of said one of the variable displacement pump-motors to function to transmit the power from the prime mover to the output member through said one of the transmission mechanisms is zero.

According to the present invention, the control system for a variable displacement pump-motor type transmission further comprises: an actuating mechanism functioning to vary the discharging amount of the variable displacement pump-motor; and the judging means includes a means for judging a fact that the discharging amount of said one of the variable displacement pump-motors is zero, based on a moving distance of the actuating mechanism or based on a position of the actuating mechanism after actuated.

The actuating mechanism includes at least any one of an actuator for varying the discharging amount of the variable displacement pump-motor, and a control unit outputting a command signal to the actuator to actuate the actuator.

According to the present invention, the control system for a variable displacement pump-motor type transmission further comprises: a fluid pressure actuator actuated by fluid pressure to vary the discharging amount of the variable displacement pump-motor; and the judging means includes a means for judging a fact that the discharging amount of said one of the variable displacement pump-motors is zero, based on a fluid pressure applied to the fluid pressure actuator.

According to the present invention, the control system for a variable displacement pump-motor type transmission comprises: a closed circuit communicating the variable displacement pump-motors. The closed circuit includes a portion where the fluid pressure is raised in case said one of the variable displacement pump-motors is locked under a driving condition in which the power from the prime mover is being transmitted to the output member, and the judging means includes a means for judging a fact that the discharging amount of said one of the variable displacement pump-motors is zero, based on the fluid pressure at the aforementioned portion.

According to the present invention, the control system for a variable displacement pump-motor type transmission further comprises: a torque detecting mechanism for detecting an output shaft torque of said one of the variable displacement pump-motors; and the judging means includes a means for judging a fact that the discharging amount of said one of the variable displacement pump-motors is zero, based on a fact that the output shaft torque detected by the torque detecting mechanism is smaller than a preset value.

In addition to above, the judging means includes a means for judging a fact that the discharging amount of said one of the variable displacement pump-motors is zero based on a speed change ratio.

According to the present invention, the control system for a variable displacement pump-motor type transmission further comprises: a correction means for correcting the speed change ratio on the basis of any of an output torque of the prime mover, an input torque to the transmission, and a torque applied to any of the variable displacement pump-motors transmitting power; and the judging means includes a means for judging a fact that the discharging amount of said one of the variable displacement pump-motors is zero, based on the speed change ratio corrected by the correction means.

According to the present invention, the control system for a variable displacement pump-motor type transmission further comprises: a learning means for obtaining a deviation between the corrected speed change ratio and a theoretical speed change ratio governed by a structure of the transmission; and the correction means includes a means for correcting the speed change ratio taking into consideration the deviation obtained by the learning means.

In addition to above, the judging means includes a means for judging a fact that the discharging amount of said one of the variable displacement pump-motors is zero, based on a rotational speed of said one of the displacement pump-motors or a rotational speed of the output member.

According to the present invention, the control system for a variable displacement pump-motor type transmission further comprises: a correction means for correcting the speed on the basis of any of an output torque of the prime mover, an input torque to the transmission, and a torque applied to any of the variable displacement pump-motors transmitting power; and the judging means includes a means for judging a fact that the discharging amount of said one of the variable displacement pump-motors is zero, based on the rotational speed corrected by the correction means.

According to the present invention, the control system for a variable displacement pump-motor type transmission further comprises: a learning means for obtaining a deviation between the corrected rotational speed and a theoretical rotational speed governed by a structure of the transmission; and the correction means includes a means for correcting the rotational speed taking into consideration the deviation obtained by the learning means.

According to the present invention, the first and the second variable displacement pump-motors are communicated with each other, and one of the variable displacement pump-motors is locked by reducing the discharging amount of the other variable displacement pump-motor to zero. The locked variable displacement pump-motor is involved in a transmission of the power from the prime mover, and the other variable displacement pump-motor whose discharging amount is zero is not involved in the power transmission. Therefore, in case the gear pair connected with the locked variable displacement pump-motor is enabled to transmit the power by the changeover mechanism, a speed change ratio in accordance with the gear ratio of the gear pair is set. That is, such speed change ratio according to the gear ratio of the gear pair is the “fixed stage”. In case the fixed stage is being set, it is judged whether or not the discharging amount of said other variable displacement pump-motor is zero, or it is judged whether or not the fixed stage is set. In this situation, if the above-explained judgment is satisfied, a changeover operation of the changeover mechanism situated on said other variable displacement pump-motor side is carried out. For this reason, the reaction force against the torque from the prime mover is ensured so that the torque will not idle away. Consequently, the speed change operation can be carried out without raising the speed of the prime mover.

Specifically, according to the present invention, the discharging amount of the variable displacement pump-motor is varied by the actuating mechanism. Therefore, the discharging amount of the variable displacement pump-motor can be detected from a moving distance of the actuating mechanism or a position of the actuating mechanism after actuated. That is, it is possible to judge the fact that the discharging amount of the variable displacement pump-motors is zero, based on the moving distance of the actuating mechanism or based on the position of the actuating mechanism after actuated. The advantage of the present invention can also be achieved by the above-explained procedure so that the speed change operation can be carried out promptly.

The actuating mechanism includes an actuator for varying the discharging amount of the variable displacement pump-motor, and a control unit applying a fluid pressure to the actuator or outputting a command signal to the actuator so as to actuate the actuator.

More specifically, the discharging amount of the variable displacement pump-motor is varied by the fluid pressure actuator provided therewith. Therefore, it is possible to judge the fact that the discharging amount of the variable displacement pump-motor is zero, or that one of the variable displacement pump-motors is locked, based on the status of the fluid pressure acting on the fluid pressure actuator. Also, the speed change operation can be carried out promptly.

In addition to the above-explained advantage, according to the present invention, the variable displacement pump-motors are communicated with each other through the closed circuit. Therefore, in case one of the variable displacement pump-motors is locked, the fluid pressure is raised at the predetermined portion in the closed circuit. For this reason, it is possible to judge the fact that the variable displacement pump-motors is locked, that the discharging amount of the other variable displacement pump-motor is zero, or that the fixed stage is set, by detecting the pressure of the portion where the pressure is raised. Thus, the advantage of the present invention can also be achieved by the above-explained procedure so that the speed change operation can be carried out promptly.

In addition to above, according to the present invention, the output shaft torque of the variable displacement pump-motor is raised when locked to be involved in the torque transmission, and to the contrary, the output shaft torque of the variable displacement pump-motor is reduced when the discharging amount thereof is zero. Therefore, it is possible to judge the fact that the discharging amount of the variable displacement pump-motor is zero, that the other variable displacement pump-motor is locked, or that the fixed stage is set, on the basis of the output shaft torque of the variable displacement pump-motor. Thus, the advantage of the present invention can also be achieved by the above-explained procedure so that the speed change operation can be carried out promptly.

As explained above, the speed change ratio of the fixed stage corresponds to the gear ratio of the transmission mechanism transmitting the power under the fixed stage. Therefore, according to the present invention, it is possible to judge the fact that the fixed stage is set, that is, that the discharging amount of the predetermined variable displacement pump-motor is zero, on the basis of the speed change ratio. Thus, the advantage of the present invention can also be achieved by the above-explained procedure so that the speed change operation can be carried out promptly.

As also explained above, the speed change ratio is set by the fluid pressure. This means that the discharging amount or the locked state of the variable displacement pump-motor, and the speed change ratio are affected if leakage of the operating fluid occurs. Therefore, according to the present invention, the speed change ratio is corrected according to the torque utilizing the fact that leakage of the fluid affects the torque. For this reason, it is possible to certainly judge the fact that the discharging amount of the predetermined variable displacement pump-motor is zero, that the fixed stage is set, or that the predetermined variable displacement pump-motor is locked, on the basis of the speed change ratio. Also, the speed change operation can be carried out promptly.

According to the present invention, the deviation between the corrected speed change ratio and a theoretical speed change ratio is obtained and the speed change ratio is corrected taking into consideration the obtained deviation. Therefore, in addition to the above-explained advantage, it is possible to accurately judge the fact that the discharging amount of the variable displacement pump-motor is zero, that the variable displacement pump-motor is locked, or that the fixed stage is set. Also, the speed change operation can be carried out promptly.

As also explained above, the operational state of the transmission is reflected in any of the speed of the predetermined variable displacement pump-motor and the speed of the output member. Therefore, it is possible to certainly judge the fact that the discharging amount of the predetermined variable displacement pump-motor is zero, that the fixed stage is set, or that the predetermined variable displacement pump-motor is locked, by detecting any of the above mentioned speeds. Also, the speed change operation can be carried out promptly.

Here, the above mentioned speeds may also be corrected on the basis of the torque applied to the predetermined variable displacement pump-motor thereby improving accuracy of the judgment.

In addition, the above mentioned correction of the speeds may also be carried out by carrying out a learning thereby improving accuracy of the judgment.

### BRIEF DESCRIPTION OF THE DRAWINGS

FIG. 1 is a skeleton diagram schematically showing one example of the transmission of the invention.

FIG. 2 is a table indicating operational states of the pump-motors and the synchronizers at each to be stage set in the transmission shown in FIG. 1.

FIG. 3 is a diagram indicating a relation between the speed change ratio and the discharging amount.

FIG. 4 is a nomographic diagram of the planetary gear mechanism indicating the case in which the torque idles away under the fixed stage.

FIG. 5 is a partial diagram schematically showing an example of providing a stroke switch.

FIG. 6 is a flowchart explaining a control example of judging the fixed stage utilizing a detection signal of the stroke switch.

FIG. 7 is a partial diagram schematically showing an example of providing a stroke sensor instead of the stroke switch.

FIG. 8 is a graph indicating a predicted instance when the discharging amount becomes zero, timings to carry out a changeover operation on the basis of the prediction, and the change in the discharging amount.

FIG. 9 is a flowchart explaining a control example to predict the instance when the discharging amount becomes zero, and to carry out the changeover operation on the basis of the prediction.

FIG. 10 is a partial diagram schematically showing an example of providing a stroke sensor with the solenoid valve.

FIG. 11 is a partial diagram schematically showing an example of providing a pressure switch or a pressure sensor with the actuator as the actuating mechanism of the invention.

FIG. 12 is a graph indicating a relation between the speed change ratio and the discharging amount, and a relation between the speed change ratio and the pressure in the closed circuit.

FIG. 13 is a flowchart explaining a control example of judging the fixed stage on the basis of an actual speed change ratio or an actual rotational speed.

FIG. 14 is a nomographic diagram of the planetary gear mechanism explaining a change in an output speed of the case in which the locked pump-motor is rotated due to an oil leakage under the fixed stage.

FIG. 15 is a flowchart explaining a control example of judging the fixed stage while correcting the speed change ratio.

FIG. 16 shows one example of a map used in the control example.

FIG. 17 is a diagram indicating a region of the speed change ratio as a criterion to judge the fixed stage.

FIG. 18 shows one example of a map in which the corrected value of the output speed is set.

FIG. 19 shows one example of a map in which an amount of leakage of the operating oil is defined.

FIG. 20 is a diagram indicating a region of the speed of the output shaft to judge the fixed stage.

### BEST MODE FOR CARRYING OUT THE INVENTION

Next, this invention will be described in connection with its specific examples. First of all, a transmission to which the invention is applied will be explained hereinafter. Specifically, the transmission to which the invention is applied comprises at least two power transmission routes so that torque can be transmitted from a prime mover to an output member through both of the power transmission routes, therefore, a speed change ratio, which is a ratio between the speeds of the prime mover and the output member, can be varied continuously. Accordingly, the present invention may also be applied to the transmission taught by the above-mentioned Japanese Patent Laid-Open No. 2006-266493.

More specifically, the aforementioned power transmission routes individually comprise a variable displacement pump-motor capable of functioning as a pump as well as a motor. In the power transmission routes, the torque is transmitted according to a discharging amount of the variable displacement pump-motors, and the variable displacement pump-motors are communicated with each other in a manner to transferring operating fluid bilaterally. Therefore, in case one of the variable displacement pump-motors functions as a pump, the torque is transmitted from the prime mover to the output member according to the discharging amount of the variable displacement pump-motor functioning as a pump. On the other hand, the operating fluid is fed from the variable displacement pump-motor functioning as a pump to the other variable displacement pump-motor thereby operating the other variable displacement pump-motor as a motor. That is, power transmission through the operating fluid is carried out at the same time. The torque is transmitted to the output member through the other power transmission route. As a result, a total of the torques transmitted through both of the power transmission routes is transmitted to the output member, and the torque transmitted by the operating fluid is varied according to the discharging amount of the pump-motor. Therefore, the speed change ratio can be varied continuously.

A transmission mechanism such as a gear pair or a belt transmission is arranged in the individual power transmission route, and each gear pair or belt transmission has a different speed change ratio. Therefore, in case of transmitting the torque through only one of the power transmission routes, a total speed change ratio of the transmission is governed by the speed change ratio of the transmission mechanism arranged on the power transmission route through which the torque has been transmitted. This kind of speed change ratio will be tentatively called a “fixed speed change ratio (or fixed stage)”. In case such fixed speed change ratio is being set, the power will not be transmitted through the fluid, therefore, the power loss can be minimized so that the power can be transmitted efficiently. Additionally, in order to use only one of the transmission mechanisms to transmit the torque, each transmission mechanism preferably comprises a changeover mechanism such as a clutch mechanism. Alternatively, it is preferable to arrange the changeover mechanism between the prime mover or the output member and the transmission mechanism.

The transmission to which the present invention is applied is adapted to transmit the power through the operating fluid. Specifically, the transmission used in the present invention may be a Hydro Static Transmission (abbreviated as HST), however, a Hydro Static Mechanical Transmission (abbreviated as HMT) having a function to set a speed change ratio by a mechanical power transmission as explained above is more preferable. The mechanical transmission may be structured arbitrarily according to need. For example, a mechanism of selecting a gear pair meshing on a constant basis using a clutch mechanism or a synchronous engaging mechanism, or a mechanism of setting a plurality of speed change ratios using a plurality of planetary gear mechanisms or complex planetary gear mechanisms may be used as the mechanical transmission. Here, the variable displacement pump-motors may be arranged in tandem between the prime mover and the output member, but may also be used as a reaction means.

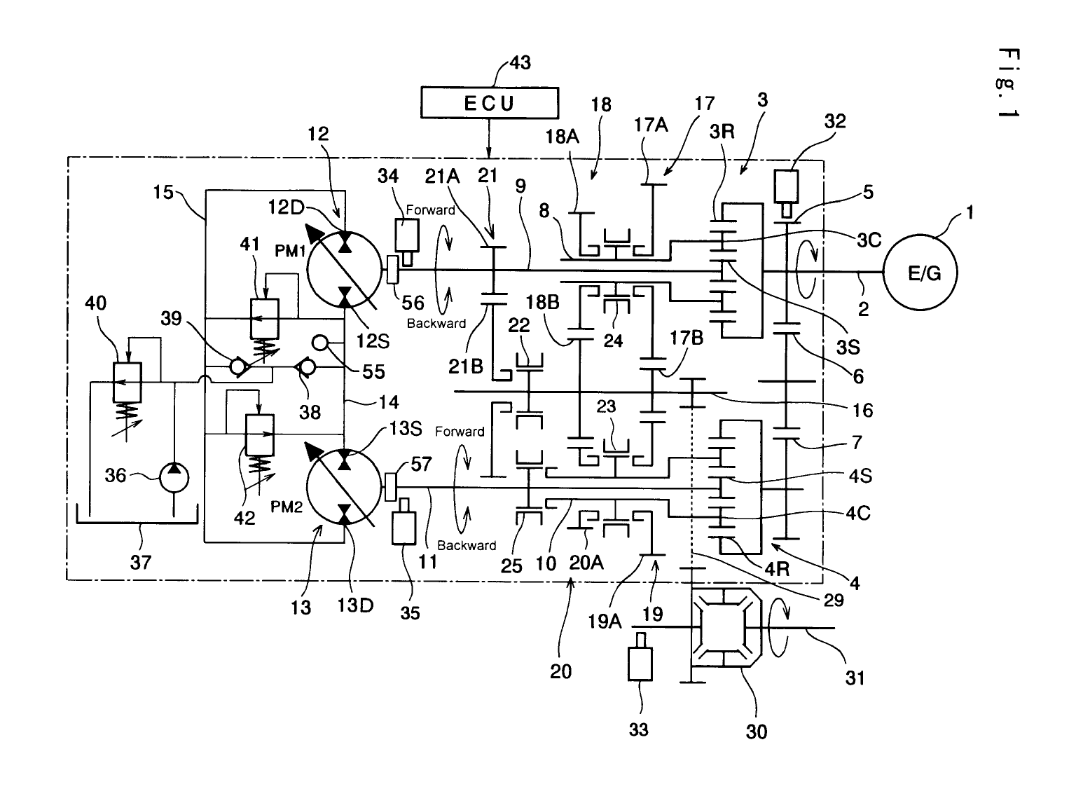

FIG. 1 shows one example of the transmission to which the present invention is applied. The transmission shown in FIG. 1 is an example of the transmission for vehicles, which is adapted to set fixed speed change ratios (or fixed stages) including four forward stages and one reverse stage by transmitting torque without interposing the fluid. Specifically, an input member 2 is connected with a prime mover (E/G) 1, and the torque is transmitted to a differential mechanism from the input member 2. Various kinds of conventional differential mechanisms may be used in the transmission, however, a first planetary gear mechanism 3 and a second planetary gear mechanism 4 are used as the differential mechanisms in the example shown in FIG. 1.

The prime mover 1 may be a general prime mover used in a vehicle such as an internal combustion engine, an electric motor or a combination thereof. An appropriate transmission means such as a damper, a clutch, a torque converter and so on may be interposed between the prime mover 1 and the input member 2.

The first planetary gear mechanism 3 is arranged coaxially with the input member 2. The second planetary gear mechanism 4 is isolated outwardly from the first planetary gear mechanism 3 in the radial direction, and arranged to align a center axis thereof in parallel with that of the first planetary gear mechanism 3. Both single pinion type and double pinion type planetary gear mechanisms can be used as the planetary gear mechanisms 3 and 4. In the example shown in FIG. 1, single pinion type planetary gear mechanisms are used as the planetary gear mechanisms 3 and 4. As can be seen from FIG. 1, the first planetary gear mechanisms 3 comprises: a sun gear 3S as an external gears; ring gear 3R as an internal gear arranged concentrically with the sun gear 3S; and a carrier 3C holding pinion gears individually meshing with the sun gear 3S and the rig gear 3R in a rotatable and revolvable manner. Also, the second planetary gear mechanisms 4 comprises: a sun gear 4S as an external gears; ring gear 4R as an internal gear arranged concentrically with the sun gear 4S; and a carrier 4C holding pinion gears individually meshing with the sun gear 4S and the rig gear 4R in a rotatable and revolvable manner. The ring gear 3R of the first planetary gear mechanism 3 is connected with the input member 2, and the ring gear 3R therefore functions as an input element.

The input member 2 is provided with a counter drive gear 5 meshing with an idle gear 6, and the idle gear 6 also meshes with a counter driven gear 7. The counter driven gear 7 is arranged coaxially with the second planetary gear mechanisms 4, and connected with the ring gear 4R to be rotated integrally. Thus, the ring gear 4R functions as an input element of the second planetary gear mechanisms 4. Since the idle gear 6 is interposed between the counter drive gear 5 and the counter driven gear 7, the ring gears 3R and 4R functioning as input elements of the planetary gear mechanisms 3 and 4 are rotated in the same direction.

The carrier 3C functions as an output element of the first planetary gear mechanism 3, and a first intermediate shaft 8 is connected with the carrier 3C to be rotated integrally. The first intermediate shaft 8 is a hollow shaft to which a motor shaft 9 is inserted in a rotatable manner, and one of end portions of the motor shaft 9 is connected with the sun gear 3S functioning as a reaction element of the first planetary gear mechanism 3 to be rotated integrally.

Also, in the second planetary gear mechanism 4, the carrier 4C functions as an output element, and a second intermediate shaft 10 is connected with the carrier 4C to be rotated integrally. The second intermediate shaft 10 is a hollow shaft to which a motor shaft 11 is inserted in a rotatable manner, and one of end portions of the motor shaft 11 is connected with the sun gear 4S functioning as a reaction element of the second planetary gear mechanism 4 to be rotated integrally.

The other end portion of the motor shaft 9 is connected with an output shaft (or a rotor shaft) of a variable displacement pump-motor 12. A hydraulic pump, for example, an angled axis pump, a swash plate pump, a radial piston pump or the like, which is capable of varying a discharging amount thereof can be used as the variable displacement pump-motor 12. In case an output shaft of the variable displacement pump-motor 12 is rotated by a torque, the variable displacement pump-motor 12 functions as a pump and discharges the operating fluid (or operating oil). To the contrary, in case the operating fluid is fed to the variable displacement pump-motor 12 from a discharging port or a suction port thereof, the variable displacement pump-motor 12 functions as a motor. Hereinafter, the variable displacement pump-motor 12 will be called as “the first pump-motor 12” and will be represented by PM1 in FIG. 1.

On the other hand, the other end portion of the motor shaft 11 is connected with an output shaft (or a rotor shaft) of a variable displacement pump-motor 13. A hydraulic pump, for example, an angled axis pump, a swash plate pump, a radial piston pump or the like, which is capable of varying a discharging amount thereof can be used as the variable displacement pump-motor 13. In case an output shaft of the variable displacement pump-motor 13 is rotated by a torque, the variable displacement pump-motor 13 functions as a pump and discharges operating fluid (or operating oil). To the contrary, in case the operating fluid is fed to the variable displacement pump-motor 13 from a discharging port or a suction port thereof, the variable displacement pump-motor 13 functions as a motor. Hereinafter, the variable displacement pump-motor 13 will be called as “the second pump-motor 13” and will be represented by PM2 in FIG. 1.

The pump-motors 12 and 13 are communicated with each other through oil passages 14 and 15 so that the operating oil can be transferred bilaterally therebetween. Specifically, suction ports 12S and 13S are communicated through the oil passage 14, and discharging ports 12D and 13D are communicated through the oil passage 15. Consequently, a closed circuit is formed by the oil passages 14 and 15. In case the pump-motor 12 is rotated in the same direction as the prime mover 1, i.e., in the forward direction, the fluid such as oil is sucked into the suction ports 12S, and discharged from the discharging ports 12D. Also, in case the pump-motor 13 is rotated in the same direction as the prime mover 1, i.e., in the forward direction, the fluid such as oil is sucked into the suction ports 13S, and discharged from the discharging ports 13D. A mechanism used to control hydraulic pressure in the closed circuit will be explained later.

An output shaft 16 corresponding to the output member of the present invention is arranged in parallel with the aforementioned intermediate shafts 8 and 10, and a transmission mechanism for setting a predetermined speed change ratio is arranged individually in a clearance between the output shaft 16 and the intermediate shaft 8 and in a clearance between the output shaft 16 and the intermediate shaft 10. According to the present invention, not only a mechanism transmitting power with a fixed speed change ratio, but also a mechanism capable of varying a speed change ratio thereof can be used as the transmission mechanism. In the example shown in FIG. 1, a plurality pf gear pairs 17, 18, 19 and 20 transmitting the power with the fixed ratio are employed.

Specifically, a fourth drive gear 17A and a second drive gear 18A are arranged on the first intermediate shaft 8 in the order from the first planetary gear mechanism 3 side, in a manner to rotate around the first intermediate shaft 8. On the other hand, a fourth driven gear 17B meshing with the fourth drive gear 17A and a second driven gear 18B meshing with the second drive gear 18A are arranged on the output shaft 16 to be rotated integrally therewith.

Also, a third drive gear 19A meshing with the fourth driven gear 17B, and a first drive gear 20A meshing with the second driven gear 18B, are arranged on the second intermediate shaft 10 in a manner to rotate therearound. That is, the fourth driven gear 17B also serves as a third driven gear, and the second driven gear 18B also serves as a first driven gear. A speed change ratio of each gear pair is governed by a ratio between a teeth number of the drive gear and a teeth number of the driven gear. According to the example shown in FIG. 1, a speed change ratio of a first gear pair 20 is the largest ratio, and the speed change ratios of a second gear pair 18, a third gear pair 19 and a fourth gear pair 17 become smaller sequentially.

In addition, there is provided a starting gear pair 21. The starting gear pair 21 is adapted to boost a driving force sufficiently to start the vehicle, by transmitting the power to the output shaft 16 in conjunction with the first gear pair 20. For this purpose, the starting gear pair 21 comprises a starting drive gear 21A arranged on a motor shaft 9 of the first pump-motor 12 side in a manner to rotate integrally with the motor shaft 9, and a starting driven gear 21B arranged on the output shaft 16 in a rotatable manner.

In order to enable the aforementioned gear pairs 17, 18, 19, 20 and 21 to transmit the torque between any of the intermediate shafts 8 and 10 and the output shaft 16, there are provided changeover mechanisms. In short, the changeover mechanism is adapted to transmit the torque selectively, and a dog clutch, a synchronizer, a frictional clutch may be used as the changeover mechanism. In the example shown in FIG. 1, a synchronizer is used as the synchronizer mechanism.

Basically, the synchronizer is adapted to connect the rotating shaft and the rotary member. More specifically, the synchronizer is adapted to synchronize a rotating shaft and a rotary member, by moving a sleeve rotating together with the rotating shaft in the axial direction to engage the sleeve with a spline of the rotary member arranged to rotate relatively with the rotating shaft, thereby contacting a synchronizer ring gradually with the rotary member during the process.

In this example, a first synchronizer 22 is arranged adjacent to the starting driven gear 21B on the output shaft 16. The first synchronizer 22 is adapted to connect the starting driven gear 21B with the output shaft 16 by moving a sleeve thereof to the left side in FIG. 1, thereby enabling the starting gear pair 21 to transmit the torque between the motor shaft 9 and the output shaft 16.

Also, a second synchronizer 23 is arranged on the second intermediate shaft 10 between the third drive gear 19A and the first drive gear 20A. The second synchronizer 23 is adapted to connect the first drive gear 20A with the second intermediate shaft 10 by moving a sleeve thereof to the left side in FIG. 1, thereby enabling the first gear pair 20 to transmit the torque between the second intermediate shaft 10 and the output shaft 16. To the contrary, in case the sleeve of the second synchronizer 23 is moved to the right side in FIG. 1, the third drive gear 19A is connected with the second intermediate shaft 10 so that the third gear pair 19 is allowed to transmit the torque between the second intermediate shaft 10 and the output shaft 16.

Moreover, a third synchronizer 24 is arranged on the first intermediate shaft 8 between the second driven gear 18B and the fourth drive gear 17A. The third synchronizer 24 is adapted to connect the second drive gear 18A with the first intermediate shaft 8 by moving a sleeve thereof to the left side in FIG. 1, thereby enabling the second gear pair 18 to transmit the torque between the first intermediate shaft 8 and the output shaft 16. To the contrary, in case the sleeve of the third synchronizer 24 is moved to the right side in FIG. 1, the fourth drive gear 17A is connected with the first intermediate shaft 8 so that the fourth gear pair 17 is allowed to transmit the torque between the first intermediate shaft 8 and the output shaft 16.

In addition, a reverse synchronizer (as will be called R synchronizer hereinafter) 25 is arranged adjacent to a shaft end of the second intermediate shaft 10 on the motor shaft 11 of the second pump-motor 13 side. The R synchronizer 25 is adapted to connect the motor shaft 11 and the second intermediate shaft 10, that is, to connect the sun gear 4S and the carrier 4C of the second planetary gear mechanism 4 by moving a sleeve thereof to the right side in FIG. 1, thereby rotating the second planetary gear mechanism 4 integrally.

The synchronizers 22, 23, 24 and 25 may be structured not only to carry out a changeover operation thereof manually but also to control the changeover operation thereof automatically. In the latter case, for example, an appropriate actuator (not shown) is provided to move the aforementioned sleeve in the axial direction, and the actuator is controlled electrically.

As described above, the transmission shown in FIG. 1 is adapted to transmit the torque outputted from the prime mover 1 to the output shaft 16 through any of the intermediate shafts 8 and 10 or any of the motor shafts 9 and 11. To the output shaft 16, a differential 30 is connected through a transmission means 29 such as a gear mechanism or belt transmission mechanism. Therefore, the power is outputted from the differential 30 to both of axles 31.

In order to detect an operating state of the transmission, the transmission is provided with sensors. Specifically, the transmission is provided with an input speed sensor 32 for detecting rotational speed N in of the input member 2 or the counter drive gear 5 integrated with the input member 2, an output speed sensor 33 for detecting rotational speed N out of the axle 31, a speed sensor 34 for detecting rotational speed N PM1 of the first pump-motor 12, a speed sensor 35 for detecting rotational speed N PM2 of the second pump-motor 13 and so on.

Next, here will be explained a fluid pressure circuit (i.e., a hydraulic circuit) for controlling the aforementioned pump-motors 12 and 13. In the aforementioned closed circuit communicating the pump-motors 12 and 13, there is provided a charge pump (also called as a “boost pump”) 36 for feeding the fluid (i.e., oil). The charge pump 36 is adapted to compensate for a shortage of the oil due to leakage of the oil from the closed circuit or the like. For this purpose, the charge pump 36 is driven by the prime mover 1 or a not shown motor to feed the oil to the closed circuit while pumping up the oil from an oil pan 37.

Therefore, a discharging port of the charge pump 36 is communicated with both of the oil passages 14 and 15 through check valves 38 and 39. The check valves 38 and 39 open to a discharging direction of the oil from the charge pump 36, and close to the opposite direction. In order to regulate a discharging pressure of the charge pump 36, a relief valve 40 is communicated with the discharging port of the charge pump 36. The relief valve 40 opens to discharge the oil to the oil pan 37, when a pressure higher than a total pressure of an elastic force of a spring and a pilot pressure or a pressing force of the solenoid is applied thereto. For this purpose, the discharging pressure of the charge pump 36 is set to a pressure according to the pilot pressure.

In addition, a relief valve 41 is arranged between a suction port 12S of the first pump-motor 12 and the oil passage 15. In other words, the relief valve 41 is arranged in parallel with the first pump-motor 12 while communicating the oil passages 14 and 15. The relief valve 41 is capable of controlling a relief pressure, and the relief valve 41 is adapted to maintain the discharging pressure of the suction port 12S of the first pump-motor 12 or the suction port 13S of the second pump-motor 13 to a preset pressure, when discharging the operating oil from the suction port 12S or the suction port 13S. Also, a relief valve 42 is arranged between the discharging port 13D of the second pump-motor 13 and the oil passage 14. In other words, the relief valve 42 is arranged in parallel with the second pump-motor 13 while communicating the oil passages 14 and 15. The relief valve 42 is capable of controlling a relief pressure, and the relief valve 42 is adapted to maintain the discharging pressure of the discharging port 12D of the first pump-motor 12 or the discharging port 13D of the second pump-motor 13 to a preset pressure, when discharging the operating oil from the discharging port 12D or the discharging port 13D.

In order to electrically control the discharging amount of the pump-motors 12 and 13, the synchronizers 22, 23, 24 and 25, and the relief pressure the relief valves 41 and 42, the transmission is provided with an electronic control unit (abbreviated as ECU) 43 composed mainly of a microcomputer. For example, a detection signal of the speed of the predetermined rotary member, or other kinds of detection signals are inputted to the electronic control unit 43, and the electronic control unit 43 carries out a calculation on the basis of the inputted signals and the data and programs stored in advance. Then, the electronic control unit 43 outputs a command signal in accordance with the calculation result.

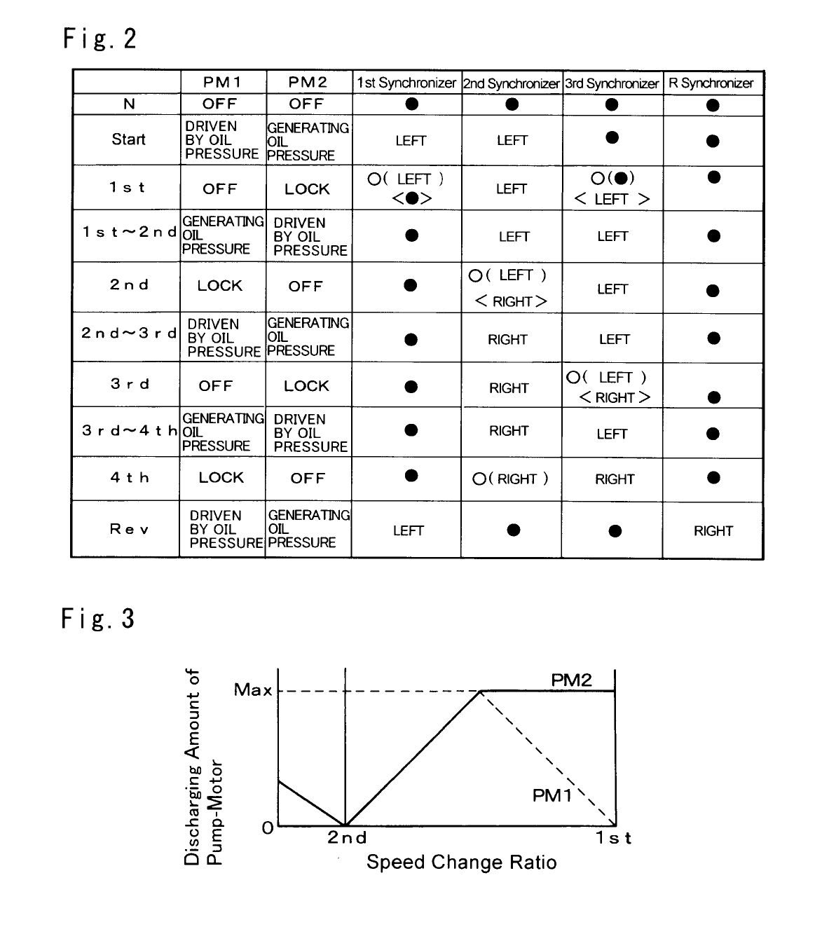

Next, here will be explained an action of the transmission. FIG. 2 is a table indicating operational states of the pump-motors 12 and 13, and the synchronizers 22, 23, 24 and 25. In the columns of the pump-motors (PM1, PM2) 12 and 13, “OFF” represents a state of the pump-motor, in which a pump capacity (i.e., a discharging amount) thereof is substantially zero, and therefore, the oil pressure will not be generated even if the output shaft thereof is rotated, or the output shaft thereof will not be rotated even if the oil pressure is applied (i.e., a free state). “LOCK” represents a state in which a rotation of a rotor of the pump-motor is halted. “GENERATING OIL PRESSURE” represents a state in which the pump capacity (i.e., discharging amount) of the pump-motor is increased larger than zero and the operating oil is being outputted, that is, represents a state in which the pump-motor is functioning as a pump. “DRIVEN BY OIL PRESSURE” represents a state in which the operating oil is fed to one of the pump-motors from the other pump-motor so that said one of the pump-motor is functioning as a motor, that is, represents a state in which the pump-motor 12 or 13 is generating a shaft torque and transmitting a drive torque to the motor shaft 9 or 11 and the intermediate shaft 8 or 10.

In the columns of the synchronizers 22, 23, 24 and 25, “RIGHT” and “LEFT” represent a position of the sleeve of synchronizers 22, 23, 24 and 25 in FIG. 1. A position indicated in the round brackets represent the position of the sleeve of each synchronizer in case the synchronizer is waiting to carry out a downshifting, a position indicated in the angle brackets represent the position of the sleeve of each synchronizer in case the synchronizer is waiting to carry out an upshifting, “◯” represents a state in which the sleeve of the synchronizer is positioned to a neutral position so that the synchronizer is set to an “OFF” state while reducing a drag torque, and “” represents a state in which the sleeve of the synchronizer is positioned to a neutral position so that the synchronizer is set to an “OFF” state.

In case of setting a neutral (N) stage of the transmission by e.g., selecting a neutral position of a not shown shifting device, the pump-motors 12 and 13 are set to the “OFF” state, and the sleeves of the synchronizers 22, 23, 24 and 25 are positioned to the neutral position. As a result, none of the gear pairs is connected with the output shaft 16 and the neutral stage of the transmission is thereby set. Specifically, the pump capacity (i.e., the discharging amount) of the pump-motors 12 and 13 are controlled to be reduced to substantially zero, and pump-motors 12 and 13 are idled as a result. Therefore, the sun gears 3S and 4S no longer function as reaction elements even if the torque is transmitted from the prime mover 1 to the ring gears 3R and 4R of the planetary gear mechanisms 3 and 4, therefore, the torque will not be transmitted to the intermediate shafts 8 and 10 connected with the carriers 3C and 4C as the output elements.

When the shift position is shifted to a drive position, the sleeve of the first synchronizer 22 is moved to the left side in FIG. 1, and the sleeve of the second synchronizer 23 is also moved to the left side in FIG. 1. As a result, the starting driven gear 21B is connected with the output shaft 16 so that the first pump-motor 12 is connected with the output shaft 16, and the first drive gear 20A is connected with the second intermediate shaft 10 so that the carrier 4C as the output element of the second planetary gear mechanism 4 is connected with the output shaft 16. That is, the first stage of the fixed speed change ratio is set. In connection therewith, the discharging amounts of the pump-motors 12 and 13 are increased to an amount larger than zero.

Consequently, the second pump-motor 13 is driven as a pump by the power of the prime mover 1 distributed by the second planetary gear mechanism 4, and the reaction torque resulting from a generation of the oil pressure is applied to the motor shaft 11 and the sun gear 4S. This situation is indicated as “GENERATING OIL PRESSURE” in FIG. 2. Therefore, the torque is transmitted to the carrier 4C by a differential action of the second planetary gear mechanism 4, and then, transmitted to the output shaft 16 through the first gear pair 20. On the other hand, the oil pressure generated by the second pump-motor 13 is discharged from the suction port 13S and fed to the suction port 12S of the first pump-motor 12. As a result, the first pump-motor 12 is rotated in the forward direction to function as a motor. This situation is indicated as “DRIVEN BY OIL PRESSURE” in FIG. 2. Thus, the power transmitted to the first pump-motor 12 is then transmitted to the output shaft 16 through the starting gear pair 21. Therefore, from the starting of the vehicle until the first stage is set, the power is transmitted mechanically though the second planetary gear mechanism 4 and also hydraulically, and a total of those powers is transmitted to the output shaft 16. Additionally, during this process, the speed change ratio is larger than the fixed speed change ratio of the first stage and varied continuously or steplessly.

When the speed of the prime mover 1 and the vehicle speed are thus varied so that the speed change ratio becomes the speed change ratio of the first stage, the first pump-motor 12 is brought into “OFF” state and the discharging amount thereof is reduced to zero. As a result, the closed circuit is closed by the first pump-motor 12. Therefore, the second pump-motor 13 is disabled to suck and discharge the operating oil. Thai is, the rotation of the second pump-motor 13 is halted and the second pump-motor 13 is thereby locked. Consequently, the sun gear 4S of the second planetary gear mechanism 4 is fixed, and the first planetary gear mechanism 3 is no longer involved in the power transmission to the output shaft 16. Therefore, the power outputted from the prime mover 1 is transmitted to the output shaft 16 through the second planetary gear mechanism 4 and the first gear pair 20. That is, the fixed speed change ratio governed by the gear ratio of the first gear pair 20 is set.

In case of carrying out an upshifting to the second stage of the fixed speed change ratio, the sleeve of the third synchronizer 24 is moved to the left side in FIG. 1 thereby connecting the second drive gear 18A with the first intermediate shaft 8. Additionally, in case of engaging the sleeve of the third synchronizer 24 with the second drive gear 18A, the synchronous control for synchronizing the speed of the sleeve of the third synchronizer 24 with the speed of the second drive gear 18A may be carried out by feeding the oil pressure of the charge pump 36 to the first pump-motor 12 to rotate the first pump-motor 12.

In this situation, the R synchronizer 25 is controlled to be neutral, and the discharging amount of the first pump-motor 12 is raised gradually to the maximum capacity. Under the standby state to carry out the upshifting to the second stage, the first pump-motor 12 is rotated backwardly. In this situation, the first pump-motor 12 functions as a pump if the discharging amount thereof is raised gradually so that the first pump-motor 12 generates oil pressure (as indicated “GENERATING OIL PRESSURE” in FIG. 2), and at the same time, a resultant reaction torque is applied to the motor shaft 9. As a result, the power is transmitted gradually through the first planetary gear mechanism 3 and the second gear pair 18. On the other hand, the oil pressure generated by the first pump-motor 12 is fed to the second pump-motor 13 so that the second pump-motor 13 functions as a motor (as indicated “DRIVEN BY OIL PRESSURE” in FIG. 2). Therefore, the power is transmitted through the second pump-motor 13, the second planetary gear mechanism 4 and the first gear pair 20. Consequently, the speed change ratio during the process of upshifting from the first stage to the second stage becomes a value between the speed change ratios of the first and the second stages and varied continuously therebetween. That is, the speed change ratio is varied continuously between the first stage and the second stage. The speed change ratio is also varied continuously between the starting of the vehicle and the first stage, and between each fixed stages. For this reason, the transmission thus has been explained is capable of functioning as a continuously variable transmission.

When the discharging amount of the second pump-motor 13 is reduced to almost zero, and the discharging amount of the first pump-motor 12 is increased to almost maximum and the rotation thereof is thereby halted or substantially halted, the second pump-motor 13 is brought into the “OFF” state. Therefore, the first pump-motor 12 is locked and the sun gear 3S of the first planetary gear mechanism 3 is fixed. As a result, the power inputted to the ring gear R3 is outputted to the second drive gear 18A through the carrier 3C and the first intermediate shaft 8. On the other hand, the second pump-motor 13 is in the “OFF” state, and the sleeves of the R synchronizer 25 and the second synchronizer 23 arranged coaxially with the second pump-motor 13 are individually positioned to the neutral position, that is, both of the R synchronizer 25 and the second synchronizer 23 are also in the “OFF” state. This means that the second pump-motor 13 and the second planetary gear mechanism 4 are not involved in the power transmission. Therefore, the fixed speed change ratio of the second stage governed by the gear ratio of the second gear pair 18 is set.

Similarly, in case of setting the third stage, the third drive gear 19A is connected with the second intermediate shaft 10 by moving the sleeve of the second synchronizer 23 to the right side in FIG. 1, and by setting the other synchronizers 22 and 24 to the “OFF” state. As a result, the power is transmitted to the output shaft 16 through the third gear pair 19, and the third stage of the fixed speed change ratio is thereby set. Also, in case of setting the fourth stage, the fourth drive gear 17A is connected with the first intermediate shaft 8 by moving the sleeve of the third synchronizer 24 to the right side in FIG. 1, and by setting the other synchronizers 23 and 25 to the “OFF” state. As a result, the power is transmitted to the output shaft 16 through the fourth gear pair 17, and the fourth stage of the fixed speed change ratio is thereby set.

In case of setting the reverse stage, in other words, in case a reverse range is selected by e.g., a shifting device not shown, the sleeve of the first synchronizer 22 is moved to the left side in FIG. 1, the sleeve of the R synchronizer 25 is moved to the right side in FIG. 1, and other synchronizers 23 and 24 are set to the “OFF” state. That is, as a result of connecting the second intermediate shaft 10 with the second motor shaft 11 by the R synchronizer 25, the sun gear 4S and the carrier 4C of the second planetary gear mechanism 4 are connected with each other so that the second planetary gear mechanism 4 is integrated entirely. Additionally, the starting driven gear 21B is connected with the output shaft 16.

Accordingly, the power transmitted from the prime mover 1 to the second planetary gear mechanism 4 is transmitted to the second pump-motor 13 as it is, thereby driving the second pump-motor 13 to generate oil pressure. Here, since the second synchronizer 23 is in the “OFF” state, the power will not be transmitted to the output shaft 16 from the second planetary gear mechanism 4 or from the second intermediate shaft 10. On the other hand, the discharging amount of the first pump-motor 12 is increased to the value larger than zero, e.g., to the maximum capacity thereof. As a result, the first pump-motor 12 is driven as a motor by the oil pressure from the second pump-motor 13 thereby outputting the torque to the motor shaft 9. In this case, the oil pressure is fed to the first pump-motor 12 from the discharging port 12D, therefore, the first pump-motor 12 is rotated backwardly. The torque of the first pump-motor 12 is transmitted to the output shaft 16 through the starting gear pair 21. As a result the reverse stage is set. Thus, the power is transmitted hydraulically under the reverse stage, as indicated “DRIVEN BY OIL PRESSURE” in the column of the first pump-motor 12 in FIG. 2, and as also indicated “GENERATING OIL PRESSURE” in the column of the second pump-motor 13 in FIG. 2.

One example of the relation between the speed change ratio of the transmission and the discharging amounts of the pump-motors 12 and 13 is shown in FIG. 3. FIG. 3 shows one example of the relation between the discharging amount and the speed change ratio in the range from the fixed first stage (abbreviated as 1st) to an intermediate stage, e.g., to 2.3rd stage. As indicated in FIG. 3, the discharging amount of one of the pump-motors is being kept to the maximum capacity when the discharging amount of the other pump-motor is being varied. Specifically, the first stage is set by enabling the first gear pair 20 to transmit the torque to the output shaft 16 by the second synchronizer 23 while reducing the discharging amount of the first pump-motor 12 to zero, and by increasing the discharging amount of the second pump-motor 13 to the maximum value thereby locking the second pump-motor 13. In this situation, the second gear pair 18 is enabled to transmit the torque by actuating the third synchronizer 24.

As a result of thus enabling the gear pairs 20 and 18 to transmit the torque while increasing the discharging amount of the first pump-motor 12 gradually, the speed change ratio between the first and the second stages is set. After the discharging amounts of both of the pump-motors 12 and 13 are raised to the maximum capacities, the discharging amount of the second pump-motor 13 is reduced gradually while keeping the discharging amount of the first pump-motor 12 to the maximum value. Consequently, the speed change ratio is further reduced toward the speed change ratio of the second stage. When the discharging amount of the second pump-motor 13 is reduced to zero, the first pump-motor 12 is locked and the second stage as a fixed stage is set. In this situation, the sleeve of the second synchronizer 23 is moved to the right side in FIG. 1 to enable the third gear pair 19 to transmit the torque. If the discharging amount of the second pump-motor 13 is increased gradually after carrying out such a changeover operation, the speed change ratio is reduced gradually from the speed change ratio of the second stage toward the speed change ratio of the third stage. That is, an upshifting is executed.

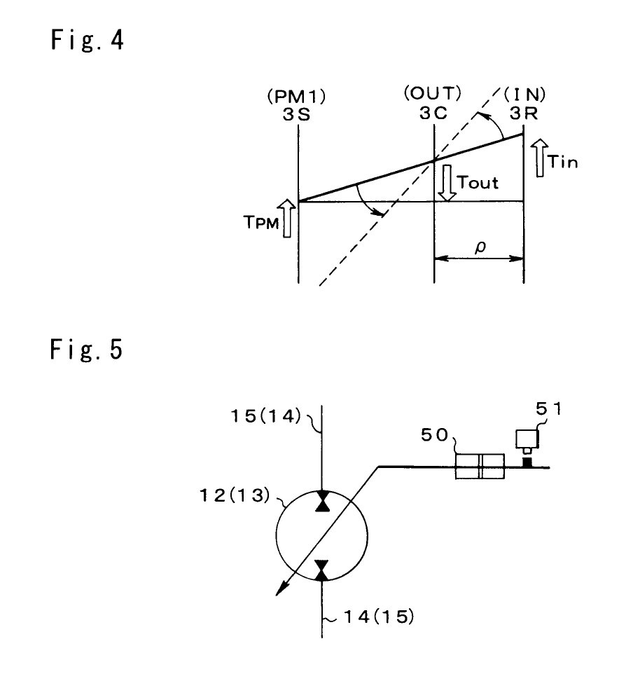

Here will be briefly explained a behavior of the first planetary gear mechanism 3 during the changeover operation of the synchronizer. FIG. 4 is a nomographic diagram of the first planetary gear mechanism 3. FIG. 4 indicates a state in which the first pump-motor 12 is locked and the sun gear S3 is fixed, that is, indicates a state in which a fixed stage is set. Specifically, torque T in from the prime mover 1 is acting on the ring gear 3R in the direction to increase the speed of the ring gear 3R, and torque T PM is acting on the sun gear 3S to hold the sun gear S3 not to rotate backwardly (i.e., in the direction opposite to the rotational direction of the prime mover 1). Thus, those torques are balanced to establish a predetermined drive torque.

This situation is realized when the discharging amount of the second pump-motor 13 is reduced to zero, and the first pump-motor 12 is thereby locked, however, if the discharging amount of the second pump-motor 13 is larger than zero, a state indicated by the broken line in FIG. 4 is caused. Specifically, if the discharging amount of the second pump-motor 13 is larger than zero, the operating oil is allowed to flow in the closed circuit so that the power is transmitted from the first pump-motor 12 to the second pump-motor 13 through the operating oil. Although the resultant torque appears on the motor shaft 11 of the second pump-motor 13, the second synchronizer 23 becomes neutral state temporarily during a changeover behavior thereof in which the sleeve thereof moves from the position to set the first stage to the position to set the second stage. That is, the reaction force is not applied to the second pump-motor 13 during the changeover operation of the second synchronizer 23, and therefore the torque idles away. As a result, the first pump-motor 12 is rotated in the backward direction, and the engine speed (i.e., the speed of the ring gear R3) is thereby raised abruptly. Thus, the speed of the engine 1 is raised abruptly.

In order to avoid the above-explained situation during the speed change operation, the following control is carried out in the present invention. FIG. 5 shows one example of the mechanism to be used to carry out such a control. As shown in FIG. 5, the pump-motors 12 and 13 are individually provided with an actuator 50 for varying the discharging amount of the pump-motors 12 and 13. The actuator 50 includes a direct acting type actuator and a rotary type actuator, and the actuator 50 is actuated hydraulically or electrically. Accordingly, the actuator 50 corresponds to the actuating mechanism of the present invention. Here, in case the pump-motor 12 or 13 is a swash plate pump, an inclination of the plate thereof is changed by the actuator 50 to vary the discharging amount, and in case the pump-motor 12 or 13 is a radial piston pump, a relative eccentricity of the rotor thereof is changed by the actuator 50 to vary the discharging amount.

The actuator 50 is provided with a sensor for detecting a position of the actuator 50 and output a signal relating to the position of the actuator 50. Specifically, the sensor is composed of a stroke switch 51, which is turned on by the actuator 50 when the actuator 50 reduces the discharging amount of the pump-motors 12 or 13 to zero. For example, the stroke switch 51 is connected with the aforementioned electronic control unit 43. Therefore, the electronic control unit 43 can judge the fact that the discharging amount is zero based on the “ON” signal outputted from the stroke switch 51.

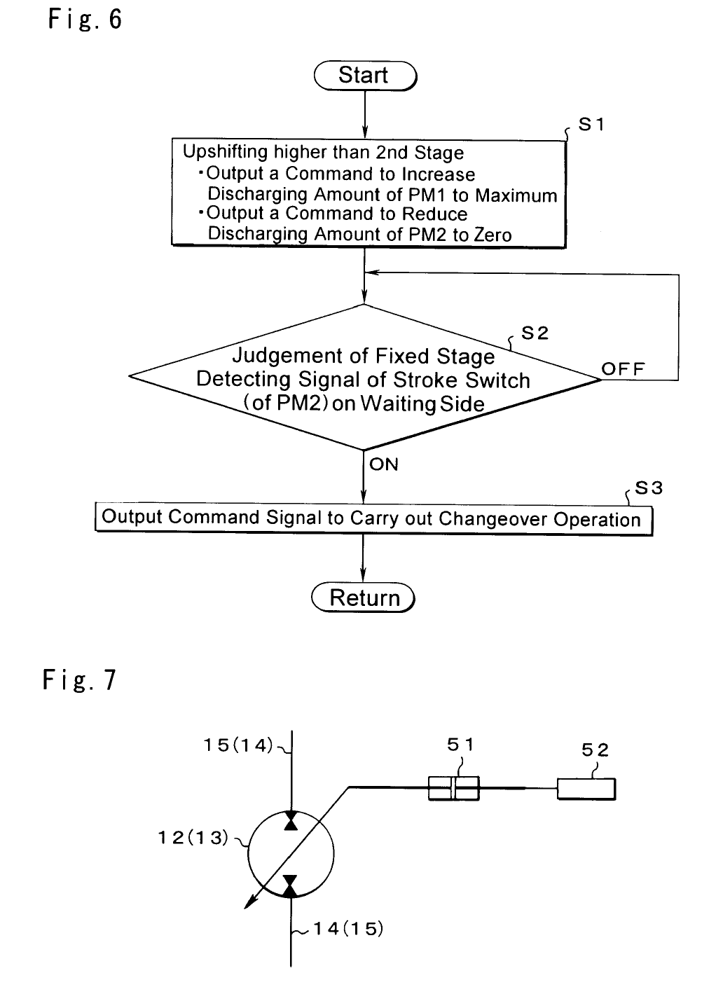

FIG. 6 is a flowchart explaining one example of a speed change control using the stroke switch 51. Specifically, FIG. 6 shows an example of carrying out a changeover operation of the second synchronizer 23 of the second pump-motor 13 side. First of all, if a judgment to carry out an upshifting to the speed change ratio higher than the second stage as a fixed stage is satisfied, under the situation in which the sleeve of the second synchronizer 23 is moved to the left side in FIG. 1 so that the first gear pair 20 is allowed to transmit the torque, and in which the sleeve of the third synchronizer 24 is moved to the left side in FIG. 1 so that the second gear pair 18 is allowed to transmit the torque, a command signal is outputted individually to the pump-motors 12 and 13 to set the discharging amounts of the pump-motors 12 and 13 (at Step S1). Specifically, under the second stage, the second gear pair 18 transmits the torque, and other gear pairs are not involved in the power transmission. Therefore, the command signal to increase the discharging amount to the maximum capacity is outputted to the first pump-motor 12 connected with the second gear pair 18. To the contrary, the command signal to decrease the discharging amount to zero is outputted to the second pump-motor 13 connected with the second synchronizer 23 by which the changeover operation is to be carried out. Here, the actuator 50 shown in FIG. 5 is actuated by those command signals.

Then, it is judged whether or not the fixed stage is set (at Step S2). In this example of the speed change operation thus far explained, the second stage is a fixed stage to be judged. Therefore, at this step S2, it is judged whether or not the first pump-motor 12 is locked, in other words, it is judged whether or not the discharging amount of the second pump-motor 13, which is positioned on the side of the synchronizer waiting to carry out the changeover operation, is reduced to zero. As shown in the above-explained FIG. 5, the pump-motors 12 and 13 are individually provided with the actuator 50, and the stroke switch 51 outputs the “ON” signal when the actuator 50 reduces the discharging amount of the pump-motors 12 or 13 to zero. Therefore, it is possible to judge the fact that the fixed stage is set on the basis of the fact that the “ON” signal is outputted.

Accordingly, in case an “OFF” signal of the stroke switch 51 has been detected at Step S2, the routine is returned to Step S1 to continue the previous control. To the contrary, in case the “ON” signal is detected at Step S2, the judgment of the fact that the fixed stage is set is satisfied so that a command to carry out a changeover operation of the synchronizer is outputted (at Step S3). Specifically, the command signal outputted at Step S3 is a command to enable the third gear pair 19 to transmit the torque to the output shaft 16, by actuating an actuator not shown to move the sleeve of the second synchronizer 23 from the first gear pair 20 side to the third gear pair 19 side.

Therefore, the changeover operation of the second synchronizer 23 can be executed by carrying out the control shown in FIG. 6, under the situation in which the first pump-motor 12 is locked, that is, under the situation in which the torque from the prime mover 1 is not acting on the second pump-motor 13. For this reason, the torque can be prevented from idling away, and therefore the speed of the prime mover 1 can be prevented from being raised abruptly, even if the sleeve of the second synchronizer 23 is situated temporarily in the neutral position during the changeover operation. Moreover, it is unnecessary to set a waiting time sufficient for waiting the discharging amount to be zero or minimum value, after a command signal for reducing the discharging amount to zero or minimum value is outputted. This means that the changeover operation of the synchronizer can be carried out immediately in accordance with the “ON” signal of the stroke switch 51 without waiting a lapse of such waiting time. For this reason, the required time for the speed change operation can be shortened so that the response of the speed change operation can be improved. Further, the stroke switch 51 as an ON/OFF switch is the only additional requirement to carry out the control shown in FIG. 6 so that the control can be carried out without requiring substantial cost.

This control shown in FIG. 6 can also be carried out in case of carrying out a changeover operation of the third synchronizer 24. In this case, the second pump-motor 13 is to be locked. Therefore, a stroke position of the actuator 50 for the first pump-motor is detected by the stroke switch 51, and the changeover operation of the third synchronizer 24 is carried out in accordance with the “ON” signal of the stroke switch 51. Here, behaviors of the elements under the fixed stage as well as the intermediate speed change ratio, and the torque transmitting status are identical to those in the example previously explained.

As shown in FIG. 7, a stroke sensor 52 can also be used instead of the stroke switch 51. The stroke sensor 52 is adapted to detect a stroke amount of the actuator 50 from a predetermined initial position, or to detect a moving distance of a member or portion moved by the actuator 50 from a predetermined initial position. The stroke sensor 52 is connected with the aforementioned electronic control unit 43, and outputs a detection signal to the electronic control unit 43. The electronic control unit 43 judges the fact that the discharging amount of the pomp-motor 12 or 13 provided with the stroke sensor 52 is zero, on the basis of the signal inputted from the stroke sensor 52. In addition, the stroke sensor 52 is capable of momentarily detecting the aforementioned moving distance or the position based on the moving distance, and the electronic control unit 43 is therefore adapted to predict an instance when the discharging amount becomes zero or minimum value on the basis of data from the stroke sensor 52.

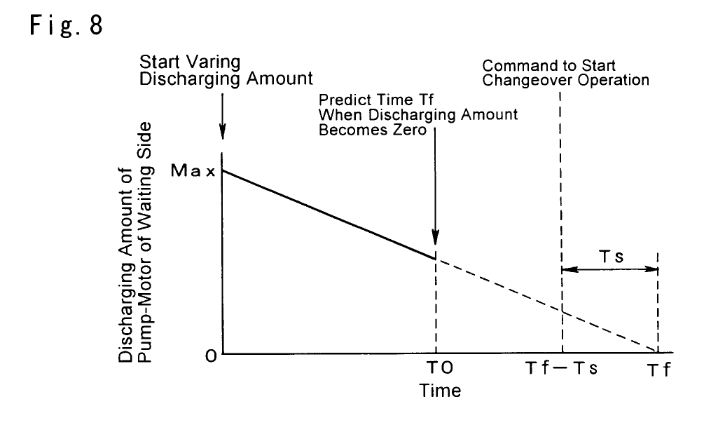

FIG. 8 is a graph indicating the prediction and a situation of the changeover operation based on the prediction. In FIG. 8, the horizontal axis represents time, and the vertical axis represents the discharging amount varied by the actuator 50. An actuating speed of the actuator 50, that is, a changing speed of the discharging amount is substantially constant unless carrying out a specific control. Therefore, in case of reducing the discharging amount, the discharging amount is reduced linearly as indicated by the solid line in FIG. 8. The reducing gradient can be obtained as a reduction of the discharging amount per unit of time by a calculation. Therefore, the time Tf when the discharging amount becomes zero or minimum value can be obtained during a process of reduction control of the discharging amount (at the time T0).

On the other hand, the delay time Ts of the synchronizers 22 to 25 can be mapped in advance based on a result of experimentation or simulation. Therefore, the aforementioned prediction of the time Tf is carried out at a comparatively earlier point of time during the process of reducing the discharging amount, and a length of the time from the point of time T0 when the prediction is carried out to the point of time Tf when the discharging amount becomes zero or minimum value is set longer than the delay time Ts. Consequently, a command signal to carry out a changeover operation of the synchronizer can be outputted at a point of time Tf-Ts when the delay time Ts commences, that is, before the point of time Tf, so as to synchronize the point of time when the synchronizer becomes the neutral state with the point of time when the discharging amount becomes zero or minimum value. In other words, the changeover operation of the synchronizer can be started in advance. Therefore, the time required for carrying out the speed change operation in which the gear pair to be used for transmitting the power is changed can be shortened. As a result, response of the speed change control can be improved.

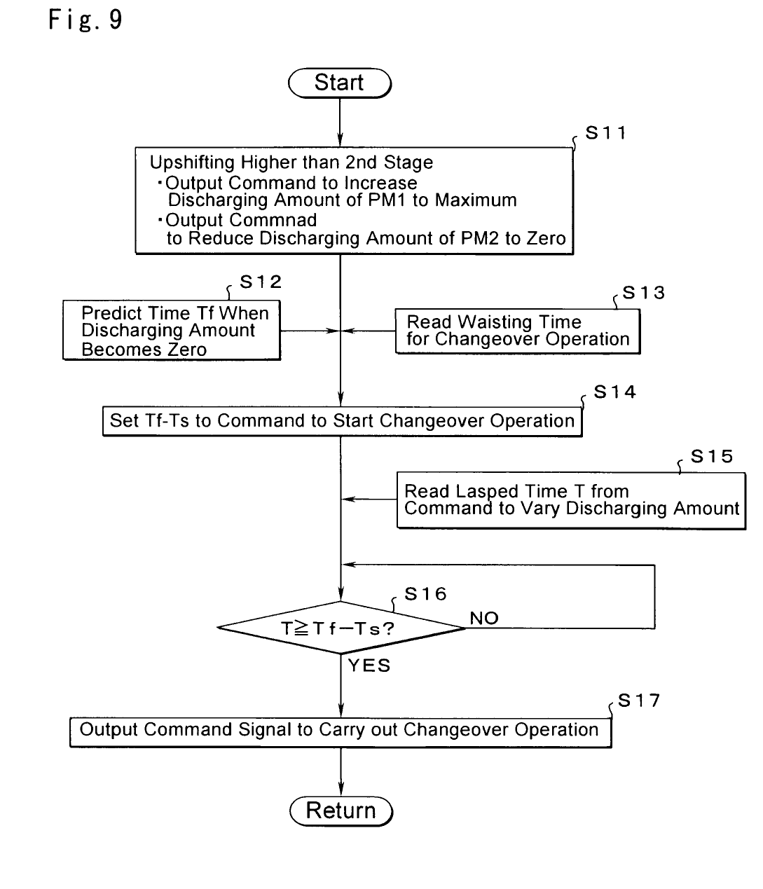

FIG. 9 is a flowchart explaining a control example of carrying out an upshifting to the speed change ratio higher than that of the second stage as a fixed stage. As shown in FIG. 9, first of all, if a judgment to carry out an upshifting to the speed change ratio higher than the fixed second stage is satisfied under the situation in which the sleeve of the second synchronizer 23 is moved to the left side in FIG. 1 so that the first gear pair 20 is enabled to transmit the torque, and the sleeve of the third synchronizer 24 is moved to the left side in FIG. 1 so that the second gear pair 18 is enabled to transmit the torque, a command signal is outputted individually to the pump-motors 12 and 13 to set the discharging amount thereof (at Step S11), likewise Step S1 in the aforementioned control example shown in FIG. 6.

Then, the instance when the discharging amount of the second pump-motor 13 becomes zero or minimum is predicted as explained above, and the predicted time Tf is read (at Step S12). At the same time, the delay time (or wasting time) Ts of the synchronizer 23 to carry out the changeover operation is read with reference to the map prepared in advance (at Step S13). Based on those times Tf and Ts, an instance to output a command to start the changeover operation (Tf-Ts) is set (at Step S14).

Then, a lapsed time T from the starting time of the control, that is, from the instance when the command signal is outputted at Step S11 is read (at Step S15). The lapsed time T is compared with the point of time (Tf-Ts) to command to start the changeover operation which has been set at Step S14 (at Step S16). That is, it is judged whether or not a current instance is the timing to start the changeover operation at Step S16. In case the answer of Step S16 is NO, the previous control is continued. To the contrary, in case the answer of Step S16 is YES, the command to start the changeover operation is outputted (at Step S17).

Therefore, the changeover operation of the second synchronizer 23 commences substantially simultaneously with the instance when the discharging amount of the second pump-motor 13 becomes almost zero or minimum, and when the sleeve of the synchronizer 23 comes to the neutral position, the discharging amount of the second pump-motor 13 becomes zero or minimum and the first pump-motor 12 is thereby locked. For this reason, the speed of the prime mover 1 will not be raised abruptly. In addition, the control to reduce the discharging amount of the second pump-motor 13 and the control to carry out the changeover operation of the synchronizer 23 can be chronologically overlapped partially. Therefore, the time required for the speed change operation can be shortened.

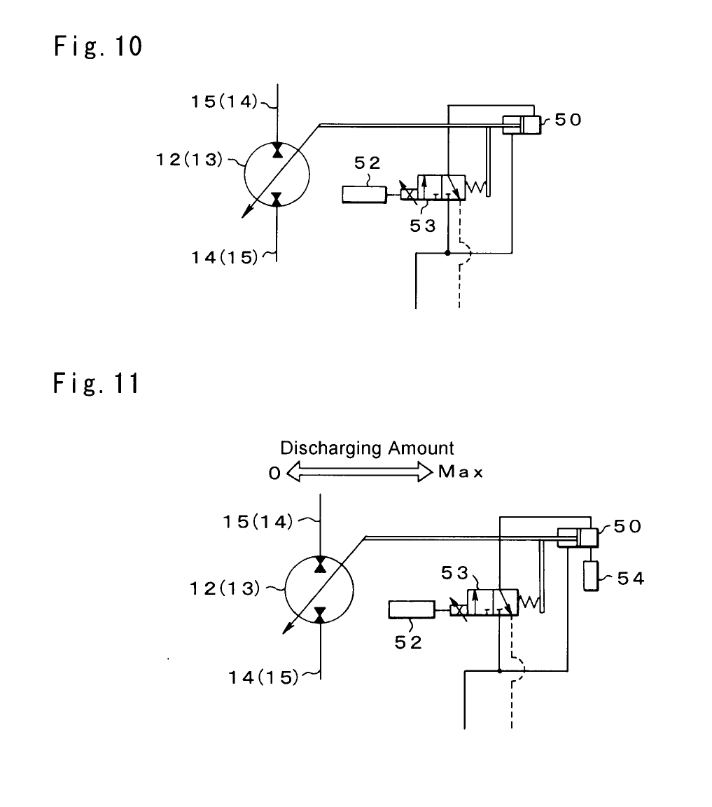

Here, the judgment of the discharging amount should not be limited to the aforementioned detection of the moving distance or the position of the actuator 50 after moved. This means that the discharging amount can also be detected on the basis of a member whose moving distance or a position after moved corresponds equally to the discharging amount, instead of the actuator 50. For this purpose, in the example shown in FIG. 10, a solenoid valve 53 for feeding and withdrawing the oil pressure to/from the actuator 50 is provided with a stroke sensor 52, and a moving distance or a position of a spool of the solenoid valve 53 is detected after moved. The solenoid valve 53 corresponds to the control mechanism of the present invention.

In case a direct acting type hydraulic actuator is used as the actuator 50, a pressure in a hydraulic chamber is low when increasing the discharging amount to the maximum, and to the contrary, the pressure in the hydraulic chamber is high when reducing the discharging amount to zero or minimum. That is, the pressure in the hydraulic chamber of the actuator 50 corresponds equally to the maximum and minimum values of the discharging amount depending on the situation. Therefore, in the example shown in FIG. 11, there is provided an oil pressure switch or sensor 54 for detecting the pressure in the predetermined hydraulic chamber of the actuator 50. For this reason, according to the example shown in FIG. 11, it is also possible to judge the fact that the discharging amount is zero or minimum, or the fact that that the discharging amount will be zero or minimum, by detecting the pressure by the oil pressure sensor 54 and inputting an output signal thereof to the aforementioned electronic control unit 43.

The pressure corresponding to the fact the discharging amount is zero or minimum also exists in the closed circuit, therefore, the discharging amount can also be judged utilizing such pressure. For example, in case the first pump-motor 12 is locked under the second stage, the torque is acting on the first pump-motor 12 in the direction to rotate the first pump-motor 12 backwardly. Consequently, the pressure in the oil passage 14 communicating the suction ports 12S and 13S is raised. Therefore, it is possible to judge the fact that the discharging pressure is (or to be) zero or minimum, by detecting the pressure raised in the oil passage 14 by an oil pressure switch or an oil pressure sensor 55 shown in FIG. 1, and inputting the detected signal to the electronic control unit 43.

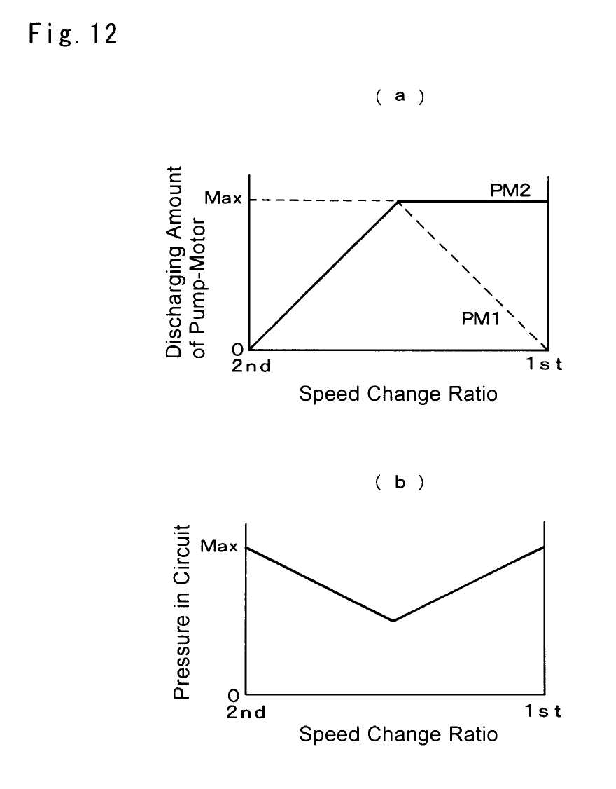

FIG. 12 (a) shows one example of a relation between the speed change ratio between the fixed first and second stages and discharging amounts of the pump-motors 12 and 13. Specifically, in FIG. 12 (a), the discharging amount of one of the pump-motors 12 and 13 is set to an intermediate value between the maximum and minimum (or zero) capacity thereof, while keeping the discharging amount of the other pump-motor 12 or 13 at the maximum capacity. The pressure in the closed circuit of this case is shown in FIG. 12 (b). As can be seen from FIG. 12 (b), the pressure in the closed circuit is raised to the maximum in case the discharging amount of one of the pump-motors is maximum and the discharging amount of the other pump-motor is zero or minimum. In case the pressure in the closed circuit is raised to the maximum, the fixed stage is to be set. Therefore, it is possible to judge the fact that the fixed stage is set, or to judge the fact that the discharging amount is zero or minimum, on the basis of the pressure detected by the oil pressure switch or oil pressure sensor 55.

The aforementioned moving amount or position after moved, and the aforementioned pressure are not the only characteristic tendencies under the fixed stage. For example, the torques of the motor shafts 9 and 11 under the fixed stage are different from those under the intermediate speed change ratio. Specifically, under the fixed stage, one of the pump-motor 12 (and 13) is involved in transmitting the torque from the prime mover 1, and the other pump-motor 13 (or 12) is idled without being involved in the torque transmission. Therefore, under the second stage or the fourth stage, a large torque is applied to the first pump-motor 12 or the motor shaft 9 thereof, and a torque applied to the second pump-motor 13 or the motor shaft 11 thereof is almost zero. To the contrary, under the first stage or the third stage, a large torque is applied to the second pump-motor 13 or the motor shaft 11 thereof, and a torque applied to the first pump-motor 12 or the motor shaft 9 thereof is almost zero. Those torques can be obtained from the engine torque and the speed change ratio.

Thus, according to the present invention, it is also possible to judge whether or not the fixed stage is set, by providing torque sensors 56 and 57 for detecting the torques of the motor shafts 9 and 11 as shown in FIG. 1 and inputting detected signal to the electronic control unit 43, and by comparing the detected torque and the engine torque or the torque governed by the speed change ratio. Accordingly, the judging means of the present invention includes a means thus judging the fixed stage on the basis of the torque.

As explained above, the fixed stage is set by fixing the reaction element of any one of the planetary gear mechanisms 3 and 4 by any one of the pump-motors 12 and 13, and by enabling any one of the gear pairs 18 to 20 to transmit the torque. That is, under the fixed stage, the speed of the predetermined rotary elements such as the output shaft 16 and the speed change ratio corresponds to the state where the discharging amount of one of the pump-motors 12 (and 13) is zero or minimum so that the other pump-motor 13 (or 12) is locked. Therefore, it is possible to judge the fact that the fixed stage is set, or to judge the fact that the discharging amount of one of the pump-motors 12 and 13 is zero or minimum, by detecting the above-explained speed or speed change ratio and comparing the detected value with the theoretical value governed by the structure of the transmission to confirm whether or not the detected value is in agreement with the theoretical value.

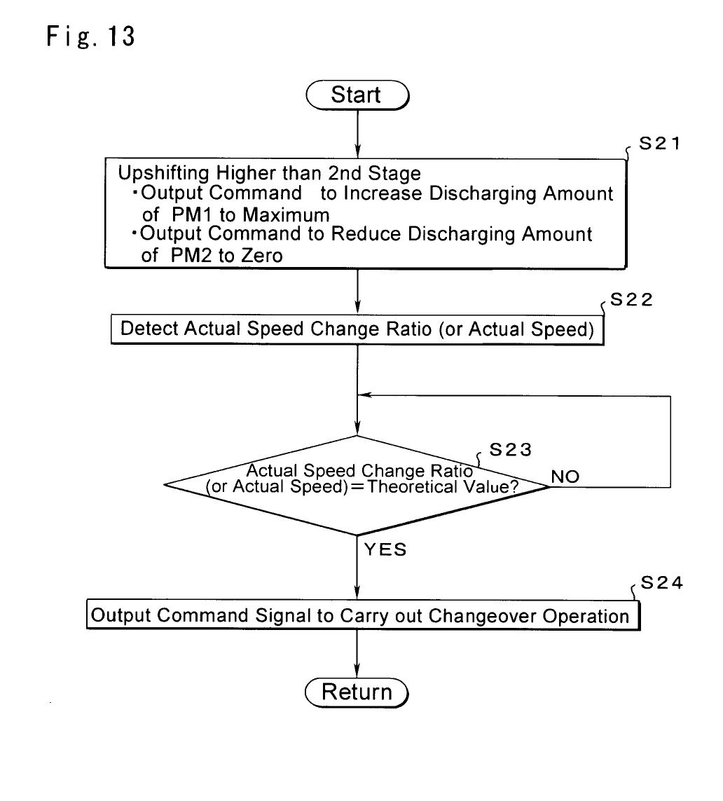

FIG. 13 is a flowchart explaining one example of the above-mentioned control. For example, in case of carrying out an upshifting to the stage higher than the second stage, a command signal for setting the discharging amount of the pump-motors 12 and 13 is outputted individually to those pump-motors 12 and 13 first of all (at Step S21), likewise Step S1 in the control examples shown in FIG. 6 and Step S11 in the control example shown in FIG. 9. Then, an actual speed change ratio or an actual rotational speed is detected (at Step S22). The detection to be carried out at Step S22 can be carried out using the input speed sensor 32 and the output speed sensor 33.

The actual speed change ratio or the actual rotational speed of the output shaft 16 or the like thus detected is compared with the theoretical value (at Step S23). As described, the theoretical value is the value governed by the structure of the transmission. Specifically, the theoretical value of the speed change ratio is a total value of the speed change ratios of the mechanisms being involved in the power transmission such as the planetary gear mechanisms 3 and 4, the gear pairs 18 to 20, the transmission means 29 and so on. On the other hand, the theoretical value of the rotational speed is determined by the input speed N in such as the engine speed and the theoretical speed change ratio. In case the actual values (i.e., the detected value) are not in agreement with the theoretical values so that the answer of Step S23 is NO, the prior control is continued. To the contrary, in case the actual values (i.e., the detected value) are in agreement with the theoretical values so that the answer of Step S23 is YES, a command signal to carry out a changeover operation of the synchronizer is outputted (at Step S24), and then the routine returns.

Thus, the synchronizer will not carry out the changeover operation thereof before the discharging amount becomes zero or minimum, even in case the control shown in FIG. 13 is carried out. Therefore, the speed of the prime mover 1 will not be raised abruptly so that the uncomfortable feeling resulting from the abrupt fluctuation in the engine speed can be minimized. Moreover, likewise the aforementioned examples, the speed change operation can be carried out promptly so that the control response can be improved.

The speed change ratio γ of the transmission shown in FIG. 1 can be obtained by the following formula:

γ=Nin/Nout=[(1+ρ)(q1Km+q2Kn)Kf]/(q1+q2).

Here, in the above formula, ρ0 represents the gear ratios of the planetary gear mechanism 3 or 4 (i.e., the ratio between the teeth number of the sun gear and the teeth number of the ring gear), q1 represents the discharging amount of the first pump-motor 12, q2 represents the discharging amount of the second pump-motor 13, Km represents the gear ratio of the second gear pair 18 or the fourth gear pair 17 being involved in transmitting the torque in the first pump-motor 12 side, Kn represents the gear ratio of the first gear pair 20 or the third gear pair 19 being involved in transmitting the torque in the second pump-motor 13 side, and Kf represents the gear ratio of the final gear such as the transmission means 29. Additionally, as a prerequisite for the above formula, the structures of the planetary gear mechanisms 3 and 4 are identical to each other. Accordingly, the theoretical speed change ratio under the fixed stage can be calculated by assigning zero to one of the discharging amount q1 (and q2), and by assigning the maximum value to the other discharging amount q2 (or q1).

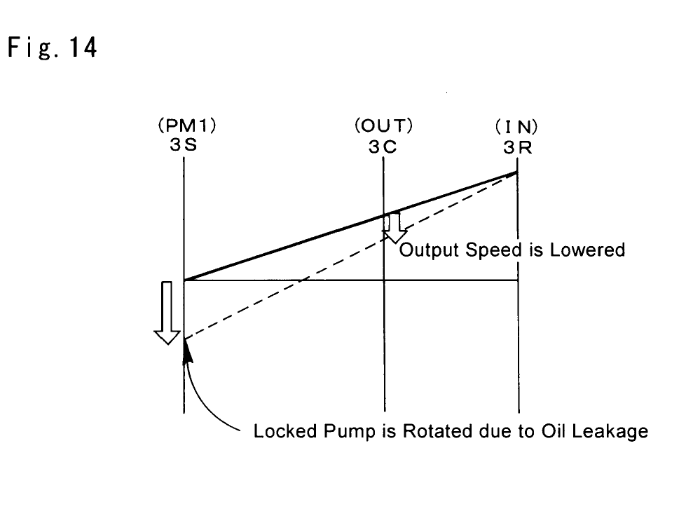

However, if a load is applied to the locked pump-motor 12 or 13, the oil pressure is thereby raised. As a result, leakage of the operating oil is caused and a leakage amount of the oil is increased. FIG. 14 is a nomographic diagram under this kind of situation. Specifically, FIG. 14 shows an example of the case in which the first pump-motor 12 being locked to set the second stage is rotated due to an oil leakage. In FIG. 14, the solid line represents the case in which no load is applied to the first pump-motor 12 and the leakage is not caused, and the broken line represent the case in which the leakage is caused by a rise in the load. As can be seen from FIG. 14, when the leakage of oil is caused, the first pump-motor 12 to be locked is rotated and the output speed is thereby lowered. As a result, the lowered actual output speed is deviated from the theoretical value of the output speed, and the detected or calculated actual speed change ratio is deviated from the theoretical value of the speed change ratio. Such deviations arise from a disturbance such as a rise in the load and the resultant leakage of the oil. That is, those errors may arise even if the discharging amount of one of the pump-motors 12 and 13 is zero.

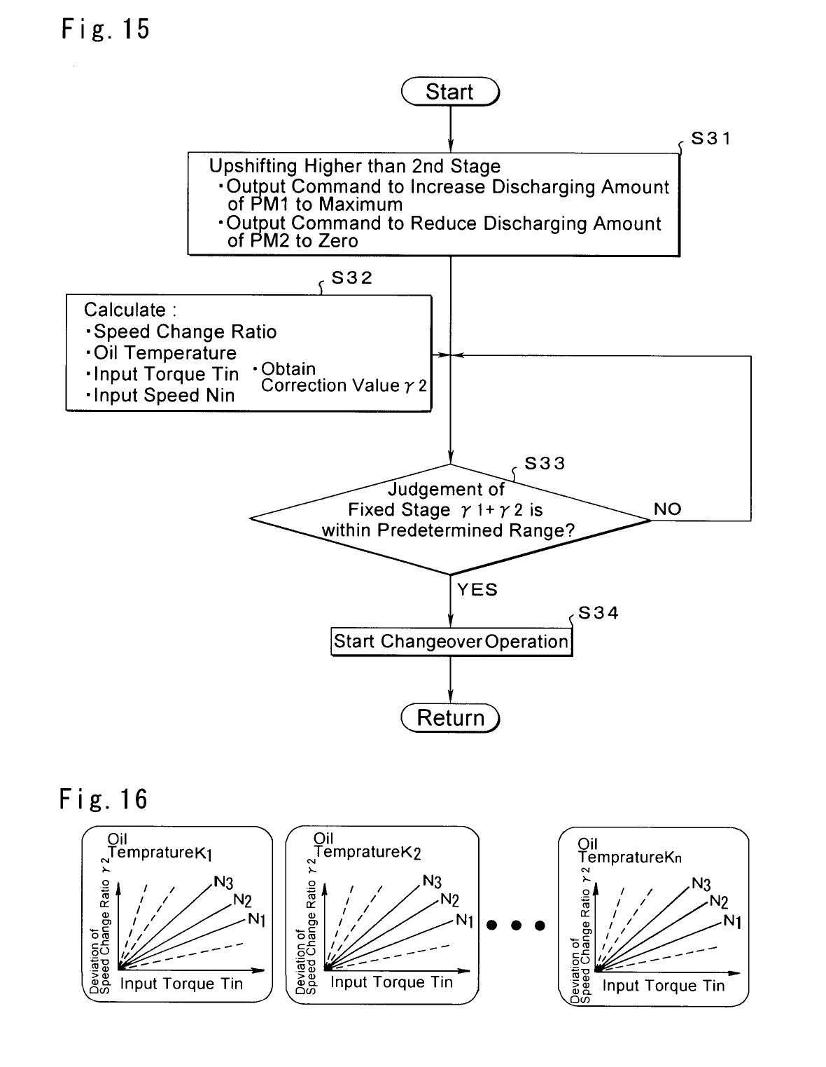

Therefore, according to the present invention, it is also possible to judge the fact that the discharging amount of one of the pump-motors 12 and 13 is zero or judge the fact that the other pump-motor 12 or 13 is locked while correcting the deviation arising from the above-mentioned disturbance. FIG. 15 is a flowchart explaining an example of carrying out this kind of control when upshifting to the stage higher than the second stage. First of all, if a judgment to carry out an upshifting to the speed change ratio higher than the fixed second stage is satisfied under the situation in which the sleeve of the second synchronizer 23 is moved to the left side in FIG. 1 so that the first gear pair 20 is enabled to transmit the power, and the sleeve of the third synchronizer 24 is moved to the left side in FIG. 1 so that the second gear pair 18 is enabled to transmit the power, a command signal is outputted individually to the pump-motors 12 and 13 to set the discharging amount thereof (at Step 31), likewise the aforementioned Steps S1, S11 and S21. Specifically, a command signal to increase the discharging amount of the first pump-motor 12 to the maximum capacity, and to reduce the second pump-motor 13 to zero or minimum value.

Meanwhile, an actual current speed change ratio γ1 is calculated, and a correction value γ2 for the speed change ratio is calculated from an oil temperature K, the input torque T in and the input speed N in (at Step S32). The actual current speed change ratio γ1 can be calculated as a ratio between the input speed N in detected by the input speed sensor 32 and the output speed N out detected by the output speed sensor 33. The oil temperature K can be detected by a sensor not shown arranged in the oil pan 37 or the like. The input torque T in can be estimated from an opening degree of a throttle of the prime mover 1, an injecting amount of fuel and so on. The correction value γ 2 can be obtained from a map prepared in advance.

As described, one of the factors to cause the deviation of the speed change ratio of the fixed stage to the lower side is an oil leakage, and the amount of the oil leakage is increased according to the rise in the torque being applied. Here, a viscosity of the operating oil is lowered according to temperature rise, and a leakage of the operating oil is caused much easier if the viscosity thereof is lowered. In addition, the amount of the oil leakage is increased according to the rise in the input speed N in. Therefore, the correction value γ2 can be mapped using the input torque T in, the oil temperature K and the input speed N in as parameters. FIG. 16 schematically shows one example of the map, and as can be seen from FIG. 16, the correction value γ2, that is, a deviation of the speed change ratio is increased according to a rise in the input torque T in, the oil temperature K (K1, K2 . . . Kn), and the input speed N in. At the aforementioned Step S32, therefore, the map is selected on the basis of the detected current oil temperature K, and the correction value γ2 is calculated from the input torque T in and the in the input speed N in using the selected map.

Then, the actual speed change ratio γ1 is corrected by the correction value γ2, and it is judged whether or not the corrected value is within a predetermined range including the theoretical value of the speed change ratio (at Step S33). Specifically, at Step S33, the deviation of the speed change ratio toward the low speed side is corrected. For this purpose, in case the correction value γ2 is a negative value, the correction value γ2 is subtracted from the actual speed change ratio γ1. To the contrary, in case the correction value γ2 is a negative value, the correction value γ2 is added to the actual speed change ratio γ1. Here, FIG. 15 shows the latter example.

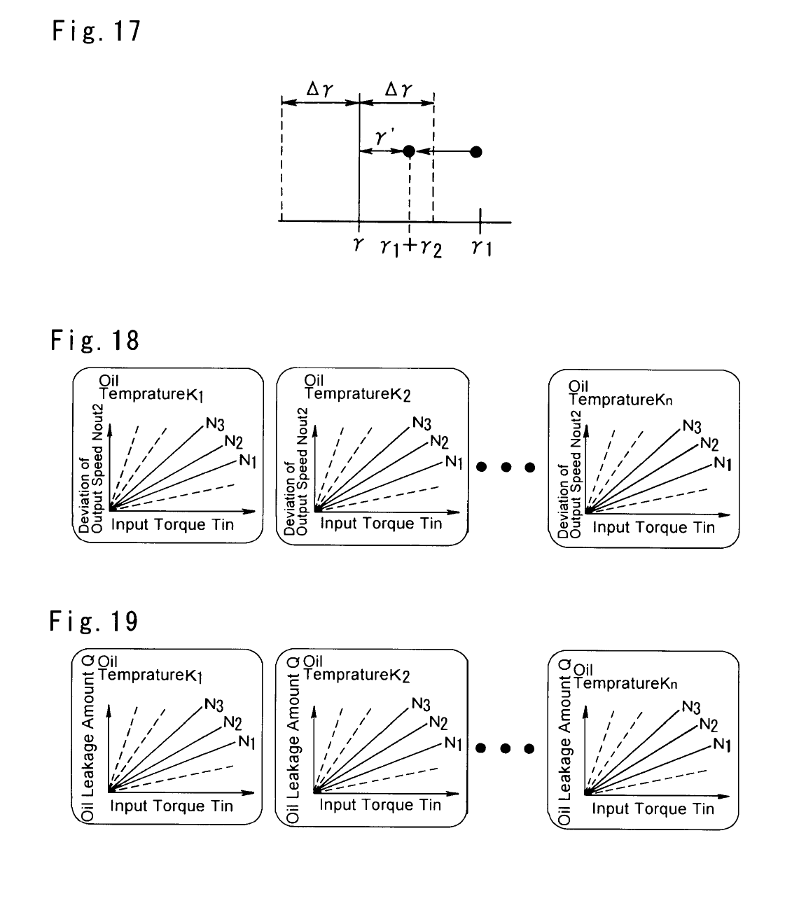

The aforementioned predetermined range as a criterion for judging the corrected speed change ratio (γ1+γ2) is prepared in advance based on a result of experimentation or simulation. As schematically shown in FIG. 17, the predetermined range is a range from a predetermined value Δ γ of the low speed side to a predetermined value Δ γ of the high speed side across the theoretical value γ of the speed change ratio situating therebetween. The predetermined value Δ γ is set as a maximum value of the deviation of the speed change ratio resulting from an assumable disturbance such as an oil leakage, or a value taking into consideration a variation in the theoretical value and the correction value. In case the vehicle is coasting, the speed change ratio is fluctuated toward the upshift side. Therefore, the predetermined range covers both of the upshift and downshift sides of the theoretical value.

In case the answer of Step S33 is YES, even if the detected or calculated speed change ratio γ1 is deviated from the theoretical value of the fixed stage, such deviation in the speed change ratio can be considered as being caused by the disturbance such as an oil leakage so that the discharging amount of the second pump-motor 13 can be considered as zero. Therefore, the changeover operation of the synchronizer is started (at Step S34). To the contrary, in case the answer of Step S34 is NO, the discharging amount of the second pump-motor 13 is not zero, and the first pump-motor 12 is therefore considered to be rotated. Therefore, the routine is returned without starting the changeover operation of the synchronizer.

Thus, it is possible to judge the fact that the fixed stage is being set immediately by carrying out the above-explained control. Therefore, the required time for the changeover operation of the synchronizer can be shortened so that the control response can be improved. Moreover, the above-explained control can be carried out utilizing the existing equipment such as the speed sensor. Therefore, an additional cost will not be required to carry out the control. Further, the synchronizer can be prevented from being neutral states prior to reducing the discharging amount of the pump-motor to zero, and the speed of the prime mover 1 is therefore prevented from being raised abruptly. Furthermore, it is possible to detect the fact that the discharging amount is not reduced to be zero on based on the speed change ratio. Therefore, a failure of the actuator varying the discharging amount, and a failure of the control device such as the solenoid valve can also be detected.

Alternatively, since the speed change ratio and the output speed (i.e., the rotational speed of the output shaft 16 or the axle 31) are correlated, the judgment of the fixed stage can be carried out on the basis of the output speed instead of the speed change ratio. In this case, the speed change ratio in FIG. 15 is replaced by the output speed or theoretical value thereof. FIG. 18 schematically shows a map of the correction value of the output speed to be used in this kind of control.

Moreover, according to the control system of the present invention, it is also possible to judge the fact that the fixed stage is set based on a corrected speed change ratio or the output speed, by obtaining an amount of oil leakage from the map, and obtaining a speed change ratio or output speed corrected by the speed of the pump-motor obtained from the amount of oil leakage. Specifically, a relation between the amount Q of oil leakage and the speed Np of the pump-motor to be locked can be expressed by the following equation:

Np=Q/q.

Here, q in the above equation represents the discharging amount of the pump-motor to be locked. On the other hand, the relation between the speed of the pump-motor to be locked and the output speed is as indicated in FIG. 14. Therefore, the output speed or the speed change ratio based on the output speed can be corrected by the amount Q of oil leakage. As shown in FIG. 19, the amount Q of oil leakage can be mapped in advance using the input torque T in, the oil temperature K and the input speed N in as parameters.

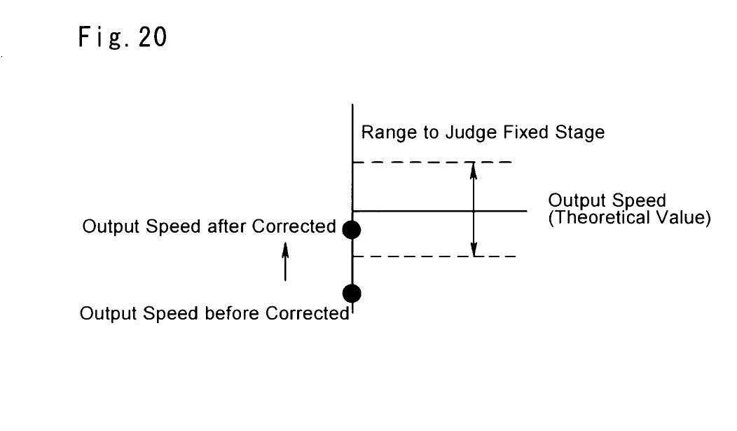

Therefore, according to the present invention, the detected or calculated output speed is corrected based on the amount of oil leakage calculated from the map, and it is judged whether or not the output speed after corrected is within the predetermined range including the theoretical value thereof (i.e., the speed of the case in which no load is applied). This range can be set as the aforementioned range of the speed change ratio, and the example thereof is schematically shown in FIG. 20. The range shown in FIG. 20 is set taking into consideration the variation of the theoretical value and the detected value. In case the corrected output speed is within the range, a judgment of the fact that the fixed stage is being set or a judgment of the fact that the discharging amount of one of the pump-motors is zero is satisfied, and the changeover operation of the synchronizer is started. Here, it is also possible to carry out this control using the speed change ratio instead of the output speed. Therefore, even if the speed change ratio and the output speed are corrected on the basis of the amount of oil leakage, the changeover operation of the synchronizer can be carried out promptly without raising the speed of the prime mover 1 abruptly, likewise the above-mentioned examples.

However, even if the above-mentioned correction is carried out, the corrected value may be deviated from the theoretical value. Such deviation is represented by γ′ in FIG. 17. This deviation is an accidental error still remaining even after eliminating the disturbance such as an oil leakage. Therefore, it can be considered that this deviation arise from a temporal factor such as aging deterioration of the oil. The deviation γ′ can be stored as a learned value to be used in the next opportunity to carry out the correction. The functional means for carrying out this kind of control corresponds to the learning means and the correction means of the present invention, and this control can be carried out in accordance with the program stored in the electronic control unit 43. Additionally, both the speed change ratio and the rotational speed can be learned and corrected in the control.

Thus, the fixed stage can also be judged while correcting the error or deviation resulting from temporal factor so that accuracy of the judgment can be improved when carrying out the changeover operation of the synchronizer.

Here, the present invention should not be limited to the above-explained examples. That is, although the examples to carryout the invention while upshifting to the stage higher than the second stage have been mainly explained in the above examples, the present invention can also be carried out in case of carrying out a speed change operation from another fixed stages. Also, the transmission to which the present invention is applied should not be limited to the transmission shown in FIG. 1, the changeover mechanism may be a frictional type instead of the synchronizer, and the number of fixed stage may also be more than four stages or less than four stages. As explained above, the variable displacement pump-motor may be a differential type, and in this case, the planetary gear mechanisms 3 and 4 may be eliminated. Further, the prime mover of the present invention should not be limited to the internal combustion engine. Specifically, an electric motor, or a hybrid drive unit in which an internal combustion engine and an electric motor is combined can also be employed as the prime mover of the invention.

Lastly, relations between the present invention and the examples will be briefly explained hereinafter. The functional means carrying out Steps S2, S16, S13 and S33 correspond to the judging means of the present invention; the functional means carrying out Steps S3, S17, S24 and S34 correspond to the speed change control means of the present invention; and the functional means carrying out Steps S32 and S33 correspond to the correction means of the present invention.

1. A control system for a variable displacement pump-motor type transmission having a first variable displacement pump-motor and a second variable displacement pump-motor which are communicated with each other in a manner to interrupt feeding and discharging of an operating fluid to/from one of the variable displacement pump-motors to lock said one of the variable displacement pump-motors when discharging amount of the other variable displacement pump-motor is zero, a first transmission mechanism transmitting power from a prime mover to an output member in case the first variable displacement pump-motor is locked, a second transmission mechanism transmitting the power from the prime mover to the output member in case the second variable displacement pump-motor is locked, a first changeover mechanism for enabling the first transmission mechanism to transmit the power, and a second changeover mechanism for enabling the second transmission mechanism to transmit the power, comprising:
a judging device for judging a fact that the discharging amount of any one of the variable displacement pump-motors is zero; and
a speed change control device for carrying out a control to disable one of the transmission mechanisms to transmit the power from the prime mover to the output member by actuating one of the changeover mechanisms, in case the judging device judges that the discharging amount of said one of the variable displacement pump-motors functioning to transmit the power from the prime mover to the output member through said one of the transmission mechanisms is zero.

2. The control system for a variable displacement pump-motor type transmission as claimed in claim 1, further comprising:
an actuating mechanism functioning to vary the discharging amount of the variable displacement pump-motor; and
wherein the judging device includes a device for judging a fact that the discharging amount of said one of the variable displacement pump-motors is zero, based on a moving distance of the actuating mechanism or based on a position of the actuating mechanism after actuated.

3. The control system for a variable displacement pump-motor type transmission as claimed in claim 2, wherein:
the actuating mechanism includes at least any one of an actuator for varying the discharging amount of the variable displacement pump-motor, and a control unit outputting a command signal to the actuator to actuate the actuator.

4. The control system for a variable displacement pump-motor type transmission as claimed in claim 1, further comprising:
a fluid pressure actuator, which is actuated by fluid pressure to vary the discharging amount of the variable displacement pump-motor; and
the judging device includes a device for judging a fact that the discharging amount of said one of the variable displacement pump-motors is zero, based on a fluid pressure applied to the fluid pressure actuator.

5. The control system for a variable displacement pump-motor type transmission as claimed in claim 1, comprising:
a closed circuit communicating the variable displacement pump-motors;
wherein the closed circuit includes a portion where the fluid pressure is raised in case said one of the variable displacement pump-motors is locked under a driving condition in which the power from the prime mover is being transmitted to the output member; and
wherein the judging device includes a device for judging a fact that the discharging amount of said one of the variable displacement pump-motors is zero, based on the fluid pressure at the aforementioned portion.

6. The control system for a variable displacement pump-motor type transmission as claimed in claim 1, further comprising:
a torque detecting mechanism for detecting an output shaft torque of said one of the variable displacement pump-motors; and
wherein the judging device includes a device for judging a fact that the discharging amount of said one of the variable displacement pump-motors is zero, based on a fact that the output shaft torque detected by the torque detecting mechanism is smaller than a preset value.

7. The control system for a variable displacement pump-motor type transmission as claimed in claim 1, wherein:
the judging device includes a device for judging a fact that the discharging amount of said one of the variable displacement pump-motors is zero based on a speed change ratio.

8. The control system for a variable displacement pump-motor type transmission as claimed in claim 7, further comprising:
a correction device for correcting the speed change ratio on the basis of any of an output torque of the prime mover, an input torque to the transmission, and a torque applied to any of the variable displacement pump-motors transmitting power; and
wherein the judging device includes a device for judging a fact that the discharging amount of said one of the variable displacement pump-motors is zero, based on the speed change ratio corrected by the correction device.

9. The control system for a variable displacement pump-motor type transmission as claimed in claim 8, further comprising:
a learning device for obtaining a deviation between the corrected speed change ratio and a theoretical speed change ratio governed by a structure of the transmission; and
wherein the correction device includes a device for correcting the speed change ratio taking into consideration the deviation obtained by the learning device.

10. The control system for a variable displacement pump-motor type transmission as claimed in claim 1, wherein:
the judging device includes a device for judging a fact that the discharging amount of said one of the variable displacement pump-motors is zero, based on a rotational speed of said one of the displacement pump-motors or a rotational speed of the output member.

11. The control system for a variable displacement pump-motor type transmission as claimed in claim 10, further comprising:
a correction device for correcting the speed on the basis of any of an output torque of the prime mover, an input torque to the transmission, and a torque applied to any of the variable displacement pump-motors transmitting power; and
the judging device includes a device for judging a fact that the discharging amount of said one of the variable displacement pump-motors is zero, based on the rotational speed corrected by the correction device.

12. The control system for a variable displacement pump-motor type transmission as claimed in claim 11, further comprising:
a learning device for obtaining a deviation between the corrected rotational speed and a theoretical rotational speed governed by a structure of the transmission; and
the correction device includes a device for correcting the rotational speed taking into consideration the deviation obtained by the learning device.

13. A control method for a variable displacement pump-motor type transmission having a first variable displacement pump-motor and a second variable displacement pump-motor which are communicated with each other in a manner to interrupt feeding and discharging of an operating fluid to/from one of the variable displacement pump-motors to lock said one of the variable displacement pump-motors when discharging amount of the other variable displacement pump-motor is zero, a first transmission mechanism transmitting power from a prime mover to an output member in case the first variable displacement pump-motor is locked, a second transmission mechanism transmitting the power from the prime mover to the output member in case the second variable displacement pump-motor is locked, a first changeover mechanism for enabling the first transmission mechanism to transmit the power, and a second changeover mechanism for enabling the second transmission mechanism to transmit the power, comprising:
judging a fact that the discharging amount of any one of the variable displacement pump-motors is zero; and
carrying out a control to disable one of the transmission mechanisms to transmit the power from the prime mover to the output member by actuating one of the changeover mechanisms, in case the discharging amount of said one of the variable displacement pump-motors functioning to transmit the power from the prime mover to the output member through said one of the transmission mechanisms is judged as zero.

14. The control method for a variable displacement pump-motor type transmission as claimed in claim 13, wherein:
variable displacement pump-motor type transmission further comprises an actuating mechanism functioning to vary the discharging amount of the variable displacement pump-motor; and
the fact that the discharging amount of said one of the variable displacement pump-motors is zero is judged based on a moving distance of the actuating mechanism or based on a position of the actuating mechanism after actuated.

15. The control method for a variable displacement pump-motor type transmission as claimed in claim 14, wherein:
the actuating mechanism includes at least any one of an actuator for varying the discharging amount of the variable displacement pump-motor, and a control unit outputting a command signal to the actuator to actuate the actuator.

16. The control system for a variable displacement pump-motor type transmission as claimed in claim 13, wherein:
the variable displacement pump-motor type transmission further comprises a fluid pressure actuator, which is actuated by fluid pressure to vary the discharging amount of the variable displacement pump-motor; and
the fact that the discharging amount of said one of the variable displacement pump-motors is zero is judged based on a fluid pressure applied to the fluid pressure actuator.

17. The control method for a variable displacement pump-motor type transmission as claimed in claim 13, wherein:
the variable displacement pump-motor type transmission comprises a closed circuit communicating the variable displacement pump-motors;
the closed circuit includes a portion where the fluid pressure is raised in case said one of the variable displacement pump-motors is locked under a driving condition in which the power from the prime mover is being transmitted to the output member; and
the fact that the discharging amount of said one of the variable displacement pump-motors is zero is judged based on the fluid pressure at the aforementioned portion.

18. The control method for a variable displacement pump-motor type transmission as claimed in claim 13, wherein:
the variable displacement pump-motor type transmission further comprises a torque detecting mechanism for detecting an output shaft torque of said one of the variable displacement pump-motors; and
the fact that the discharging amount of said one of the variable displacement pump-motors is zero is judged based on a fact that the output shaft torque detected by the torque detecting mechanism is smaller than a preset value.

19. The control method for a variable displacement pump-motor type transmission as claimed in claim 13, wherein:
the fact that the discharging amount of said one of the variable displacement pump-motors is zero is judged based on a speed change ratio.

20. The control method for a variable displacement pump-motor type transmission as claimed in claim 19, further comprising:
correcting the speed change ratio on the basis of any of an output torque of the prime mover, an input torque to the transmission, and a torque applied to any of the variable displacement pump-motors transmitting power; and
wherein the fact that the discharging amount of said one of the variable displacement pump-motors is zero is judged based on the corrected speed change ratio.

21. The control method for a variable displacement pump-motor type transmission as claimed in claim 20, further comprising:
learning a deviation between the corrected speed change ratio and a theoretical speed change ratio governed by a structure of the transmission; and
wherein the speed change ratio is corrected taking into consideration the learned deviation.

22. The control method for a variable displacement pump-motor type transmission as claimed in claim 13, wherein:
the fact that the discharging amount of said one of the variable displacement pump-motors is zero is judged based on a rotational speed of said one of the displacement pump-motors or a rotational speed of the output member.

23. The control method for a variable displacement pump-motor type transmission as claimed in claim 22, further comprising:
correcting the speed on the basis of any of an output torque of the prime mover, an input torque to the transmission, and a torque applied to any of the variable displacement pump-motors transmitting power; and
wherein the fact that the discharging amount of said one of the variable displacement pump-motors is zero is judged based on the corrected rotational speed.

24. The control system for a variable displacement pump-motor type transmission as claimed in claim 23, further comprising:
learning a deviation between the corrected rotational speed and a theoretical rotational speed governed by a structure of the transmission; and
wherein the rotational speed is corrected taking into consideration the learned deviation.
